(19) United States
(12) Patent Application Publication
(10) Pub. No.: US 2023/0270212 A1
(43) Pub. Date: Aug. 31, 2023

(54) METHOD FOR GENERATING FOOT SHAPE SPECIFICATION DATA, METHOD FOR MANUFACTURING SHOE, METHOD FOR SEARCHING READY-MADE SHOES, ASSISTANCE SYSTEM FOR CUSTOM SHOE MANUFACTURING, AND READY-MADE SHOE SEARCH SYSTEM

(71) Applicant: OSHIMA-SHOJI CO., LTD., Ichinomiya-shi, Aichi-ken (JP)

(72) Inventors: Noboru OSHIMA, Ichinomiya-shi (JP); Yui OSHIMA, Ichinomiya-shi (JP)

(73) Assignee: OSHIMA-SHOJI CO., LTD., Ichinomiya-shi, Aichi-ken (JP)

(21) Appl. No.: 18/019,691

(22) PCT Filed: Aug. 3, 2021
(86) PCT No.: PCT/JP2021/028847

§ 371 Date: Feb. 3, 2023

(30) Foreign Application Priority Data
Aug. 7, 2020 (JP) 2020-135272

(51) Int. Cl. A43D 1/02; A43D 3/02

(52) U.S. Cl. CPC A43D 1/025; A43D 3/02

(57) ABSTRACT

A method for generating foot shape specification data includes obtaining foot shape 3D data (FS3D) by measuring the three-dimensional shape of a bare foot (BF) of a subject (P) of measurement; generating a virtual insole (VIS) for measurement based on the obtained foot shape 3D data (FS3D); generating corrected foot shape 3D data (CFSD) by adding the data of the virtual insole (VIS) to a sole portion of the obtained foot shape 3D data; and obtaining foot shape specification data (FSSD) by measuring a predefined dimension of the corrected foot shape 3D data (CFSD) to determine a foot shape.

### TECHNICAL FIELD

The present disclosure relates to a method for generating foot shape specification data, a method for producing shoes, a ready-made shoe search method, a custom shoe production assisting system, and a ready-made shoe search system for providing shoes that fit the feet.

### BACKGROUND ART

To produce comfortable custom shoes that fit well, it is important that the feet are accurately measured and the measured dimensions are reflected in the shoe production. Conventionally, these have been done by skilled professionals through their intuitions.

The production of custom shoes relies on the intuitions of skilled professionals and requires repeated fittings and adjustments of the shoe lasts through trial and error. Accordingly, the production of custom shoes is generally low in productivity and high in cost.

To enable even an unskilled salesperson, for example, to easily perform accurate measurement to produce custom shoes that fit the feet, the inventors of the present invention have proposed a foot size measurement tool described in Patent Literatures 1, 2, 3, and 6 and a shoe last production method and a shoe production method in Patent Literatures 4 and 5.

These methods allow an unskilled salesperson or the like to easily perform accurate measurement to produce custom shoes that fit the feet.

The above techniques assist a person in measuring and the like. In recent years, with the spread of three-dimensional scanners, attempts have been made to convert the three-dimensional shapes of feet into data using a three-dimensional scanner and take measurements of the feet based on the data.

In the shoe production method described in Patent Literature 7, three-dimensional data of feet is measured by a three-dimensional scanner, and a computing portion generates a last model based on the digital data of the three-dimensional shape.

Patent Literature 8 describes a shoe last production method including measuring the three-dimensional shape of a foot of a customer using a three-dimensional shape measurement device (step 1), producing a female mold for producing a last for the customer based on the measurement data of the three-dimensional shape of the customer's foot, and producing a flexible last using the female mold.

Three-dimensional point cloud data obtained by the three-dimensional shape measurement device is first converted by a data conversion device into three-dimensional CAD data representing the shape of the foot using surface creation software such as Surfacer (step 2). The data is then converted into three-dimensional CAD data representing a female mold for producing a last corresponding to the foot shape (step 3). As the three-dimensional CAD data, polygon data, data mathematically describing freeform surfaces, or the like may be used.

The three-dimensional CAD data representing the female mold thus obtained is transmitted to a last maker via a public line or a network, for example. Based on the three-dimensional CAD data representing the female mold for producing a last corresponding to the shape of the customer's foot obtained from a shoe shop, the last maker produces a flexible last (male mold).

The “shoe last production method and the shoe production method measure the three-dimensional shape of a customer's foot using a three-dimensional shape measurement device. As such, the person who takes measurements does not have to be highly skilled, and anyone can easily produce shoes that fit the customer's feet.

In the “3D object tracking disclosed in Patent Literature 9, a three-dimensional shape measurement device can easily obtain an accurate three-dimensional shape with a mobile terminal. Furthermore, the three-dimensional object shape estimation device disclosed in Patent Literature 10 obtains 3D data by photogrammetry using a smartphone.

As described above, techniques are known that obtain three-dimensional data of the shape of feet to produce shoes that fit the feet.

### CITATION LIST

### Patent Literature (Non-Patent Literature)

Patent Literature 1: Japanese Patent No. 3479019

Patent Literature 2: Japanese Patent No. 4087747

Patent Literature 3: Japanese Patent No. 5073316

Patent Literature 4: Japanese Patent No. 5289366

Patent Literature 5: Japanese Patent No. 6100963

Patent Literature 6: Japanese Patent No. 6684003

Patent Literature 7: Japanese Patent Application Publication No. 2004-305449

Patent Literature 8: Japanese Patent Application Publication No. 2003-52416

Patent Literature 9: Japanese National Phase Laid-Open Patent Publication No. 2014-533867

Patent Literature 10: Japanese Patent Application Publication No. 2017-130008

### SUMMARY OF INVENTION

### Technical Problem

The shoes disclosed in Patent Literature 7 eventually need to be tried on by the person to correct any problems.

Although the method of Patent Literature 8 may produce shoes that fit the feet, it fails to produce comfortable custom shoes without an actual fitting of the shoes.

This is because shoes are functional items serving as tools for dynamic walking and the like, and shoes that simply fit the shapes of the feet are not necessarily comfortable to walk. Furthermore, shoes have aesthetic features for making the feet and shoes look beautiful by processing leather or the like.

As such, simply recording the shapes of bare feet as they are as in Patent Literatures 7 and 8 is not enough to produce comfortable custom shoes.

The present disclosure provides a method for generating foot shape specification data, a method for producing shoes, a ready-made shoe search method, a custom shoe production assisting system, and a ready-made shoe search system for providing comfortable shoes or for providing shoes with an aesthetically pleasing shape.

### Solution to Problem

A method for generating foot shape specification data according to one aspect of the present disclosure includes: obtaining foot shape 3D data by measuring a three-dimensional shape of a bare foot of a subject of measurement; generating a virtual insole for measurement based on the obtained foot shape 3D data; generating corrected foot shape 3D data by adding the data of the virtual insole a sole portion of the obtained foot shape 3D data; and obtaining foot shape specification data by measuring a predefined dimension of the corrected foot shape 3D data to determine the shape of the foot.

### DESCRIPTION OF EMBODIMENTS OF PRESENT DISCLOSURE

First, the embodiments of the present disclosure are listed and described.

### EXAMPLE [1]

A method for generating foot shape specification data according to one aspect of the present disclosure includes: obtaining foot shape 3D data by measuring a three-dimensional shape of a bare foot of a subject of measurement; generating a virtual insole for measurement based on the obtained foot shape 3D data; generating corrected foot shape 3D data by adding the data of the virtual insole a sole portion of the obtained foot shape 3D data; and obtaining foot shape specification data by measuring a predefined dimension of the corrected foot shape 3D data to determine the shape of the foot.

### EXAMPLE [2]

Another method for generating foot shape specification data according to the present disclosure includes: obtaining foot shape data that is data on a shape of a bare foot of a subject of measurement; determining a measurement insole based on the obtained foot shape data; generating corrected foot shape 3D data by measuring a three-dimensional shape of the foot of the subject of measurement with the determined measurement insole placed on a sole of the subject of measurement; and obtaining foot shape specification data by measuring a predefined dimension of the corrected foot shape 3D data to identify a shape of the foot.

### EXAMPLE [3]

Another method for generating foot shape specification data according to the present disclosure includes: obtaining foot shape data that is data on a shape of a bare foot of a subject of measurement; determining a measurement insole based on the obtained foot shape data; obtaining corrected foot shape 3D data by measuring a three-dimensional shape of the foot of the subject of measurement using a measurement sock including the determined measurement insole with the measurement insole placed on a sole of the subject of measurement; and obtaining foot shape specification data by measuring a predefined dimension of the corrected foot shape 3D data to specify a shape of the foot.

### EXAMPLE [4]

In the above examples [1] to [3], the foot shape specification data may include a corrected instep girth based on the corrected foot shape 3D data.

### EXAMPLE [5]

A method for producing shoes of the present disclosure includes: selecting a corresponding shoe last from a plurality of shoe lasts based on the foot shape specification data according to any one of examples [1] to [4]; and producing a shoe using the selected shoe last.

### EXAMPLE [6]

The method for producing shoes according to example [5] may further include modifying the selected shoe last based on the corrected foot shape 3D data.

### EXAMPLE [7]

A method for producing shows may include: selecting corresponding shoe last data from a plurality of pieces of shoe last data based on the foot shape specification data according to any one of examples [1] to [4]; and correcting the shoe last data based on the corrected foot shape 3D data; and producing a shoe last with a 3D printer based on the corrected shoe last data.

### EXAMPLE [8]

A ready-made shoe search method of the present disclosure includes: selecting, corresponding to the foot shape specification data according to any one of examples [1] to [4], a matching ready-made shoe from a plurality of ready-made shoes having ready-made shoe shape specification data registered in advance; and displaying the selected ready-made shoe.

### EXAMPLE [9]

A custom shoe production assisting system of the present disclosure includes a computer and is configured to assist custom shoe production in which custom shoes are produced using shoe lasts. The computer is configured to: obtain foot shape 3D data by measuring a three-dimensional shape of a bare foot of a subject of measurement; generate data of a virtual insole for measurement based on the obtained foot shape 3D data; generate corrected foot shape 3D data by adding the data of the virtual insole to a sole portion of the obtained foot shape 3D data; obtain foot shape specification data by measuring a predefined dimension of the corrected foot shape 3D data to determine a foot shape; and select a shoe last corresponding to the foot shape specification data from a plurality of shoe lasts.

### EXAMPLE [10]

Another custom shoe production assisting system of the present disclosure includes a computer and is configured to assist custom shoe production in which custom shoes are produced using shoe lasts. The computer is configured to obtain foot shape data that is data on a shape of a bare foot of a subject of measurement; determine a measurement insole based on the obtained foot shape data; generate corrected foot shape 3D data by measuring a three-dimensional shape of the foot of the subject of measurement with the determined measurement insole placed on a sole of the subject of measurement; obtain foot shape specification data by measuring a predefined dimension of the corrected foot shape 3D data to determine a shape of the foot; and select a shoe last corresponding to the foot shape specification data from a plurality of shoe lasts.

### EXAMPLE [11]

Another custom shoe production assisting system of the present disclosure includes a computer and is configured to assist custom shoe production in which custom shoes are produced using shoe lasts. The computer is configured to obtain foot shape data that is data on a shape of a bare foot of a subject of measurement; determine a measurement insole based on the obtained foot shape data; obtain corrected foot shape 3D data by measuring a three-dimensional shape of the foot of the subject of measurement using a measurement sock including the determined measurement insole with the measurement insole placed on a sole of the foot of the subject of measurement; obtain foot shape specification data by measuring a predefined dimension of the corrected foot shape 3D data to determine a shape of the foot; and select a shoe last corresponding to the foot shape specification data from a plurality of shoe lasts.

### EXAMPLE [12]

A custom shoe production assisting system of the present disclosure is a custom shoe production assisting system for assisting custom shoe production in which custom shoes are produced using shoe lasts, the system comprising: a foot shape specification data provider terminal configured such that foot shape specification data is input to the foot shape specification data provider terminal, wherein the foot shape specification data is obtained by the method for generating foot shape specification data according to any one of examples [1] to [4], or by manually measuring the foot shape specification data by a measurer with a measurement insole placed on a foot of a subject of measurement, and the foot shape specification data provider terminal is configured to transmit the input foot shape specification data; and a shoe last maker terminal configured to identify a corresponding shoe last from a plurality of shoe lasts based on the foot shape specification data transmitted from the foot shape specification data provider terminal. The transmitted foot shape specification data includes a corrected instep girth.

### EXAMPLE [13]

A ready-made shoe search system of the present disclosure includes a computer and is configured to retrieve a ready-made shoe suitable for a subject of measurement. The computer is configured to: obtain foot shape 3D data by measuring a three-dimensional shape of a bare foot of a subject of measurement; generate data of a virtual insole for measurement based on the obtained foot shape 3D data; generate corrected foot shape 3D data by adding the data of the virtual insole to a sole portion of the obtained foot shape 3D data; obtain foot shape specification data by measuring a predefined dimension of the corrected foot shape 3D data to determine a foot shape; and select a ready-made shoe corresponding to the foot shape specification data from a plurality of ready-made shoes.

### EXAMPLE [14]

A ready-made shoe search system of the present disclosure includes a computer and is configured to retrieve a ready-made shoe suitable for a subject of measurement. The computer is configured to: obtain foot shape data that is data on a shape of a bare foot of a subject of measurement; determine a measurement insole based on the obtained foot shape data; generate corrected foot shape 3D data by measuring a three-dimensional shape of the foot of the subject of measurement with the determined measurement insole placed on a sole of the subject of measurement; obtain foot shape specification data by measuring a predefined dimension of the corrected foot shape 3D data to determine a shape of the foot; and select a ready-made shoe corresponding to the foot shape specification data from a plurality of ready-made shoes.

### EXAMPLE [15]

A ready-made shoe search system of the present disclosure includes a computer and is configured to retrieve a ready-made shoe suitable for a subject of measurement. The computer is configured to: obtain foot shape data that is data on a shape of a bare foot of a subject of measurement; determine a measurement insole based on the obtained foot shape data; obtain corrected foot shape 3D data by measuring a three-dimensional shape of the foot of the subject of measurement using a measurement sock including the determined measurement insole with the measurement insole placed on a sole of the subject of measurement; obtain foot shape specification data by measuring a predefined dimension of the corrected foot shape 3D data to determine a shape of the foot; and select a ready-made shoe corresponding to the foot shape specification data from a plurality of ready-made shoes.

### EXAMPLE [16]

A ready-made shoe search system of the present disclosure is a ready-made shoe search system for retrieving ready-made shoes suitable for a subject of measurement, the system including: a foot shape specification data provider terminal configured such that foot shape specification data is input to the foot shape specification data provider terminal, wherein the foot shape specification data is obtained by the method for generating foot shape specification data according to any one of examples [1] to [3], or by manually measuring the foot shape specification data by a measurer with a measurement insole placed on a foot of the subject of measurement, and the foot shape specification data provider terminal is configured to transmit the input foot shape specification data; and a ready-made shoe selection information provider terminal configured to receive the transmitted foot shape specification data, retrieve ready-made shoes matching the subject of measurement based on the received foot shape specification data, and provide information on the retrieved ready-made shoes. The transmitted foot shape specification data includes a corrected instep girth.

### EXAMPLE [17]

When the ready-made shoe is retrieved, the foot shape specification data of the ready-made shoe may be compared with corresponding ready-made shoe shape specification data.

### EXAMPLE [18]

A method for generating foot shape specification data of the present disclosure may include: attaching, to a sole of a subject of measurement, a foot orthosis for correcting a shape of the sole according to the shape of the sole of the subject of measurement; generating corrected foot shape 3D data by measuring a three-dimensional shape of the foot of the subject of measurement with the foot orthosis attached; obtaining foot shape specification data by measuring a predefined dimension of the corrected foot shape 3D data to determine a shape of the foot.

### EXAMPLE [19]

A method for generating foot shape specification data of the present disclosure may include: producing a foot orthosis to be attached to a sole of a subject of measurement to correct a shape of the sole according to the shape of the sole of the subject of measurement; obtaining corrected foot shape 3D data by measuring a three-dimensional shape of a foot of the subject of measurement with the produced foot orthosis placed on the sole of the subject of measurement using a measurement sock; and obtaining foot shape specification data by measuring a predefined dimension of the corrected foot shape 3D data to determine a shape of the foot.

### EXAMPLE [20]

The foot shape specification data may include a corrected instep girth based on the corrected foot shape 3D data.

### BRIEF DESCRIPTION OF DRAWINGS

FIG. 1 is a side view showing the bare left foot of a subject of measurement who will wear custom shoes.

FIG. 2 is a diagram showing the outer shape and skeleton of the bare left foot of a subject of measurement who will wear custom shoes, in which part (a) shows its right side view and part (b) shows its plan view.

FIG. 3 is a right side view of a shoe last for left foot.

FIG. 4 is a diagram showing the outer shape of the bare left foot of a subject of measurement wearing a measurement insole/virtual insole, in which part (a) shows its right side view and part (b) shows its plan view.

FIG. 5 is a perspective view showing a lasting step.

FIG. 6 is a block diagram showing an overall configuration of the present system.

FIG. 7 is a block diagram showing the configuration of a user terminal.

FIG. 8 is a flowchart of foot shape specification data transmission with the user terminal.

FIG. 9 is a perspective view showing a method of measuring foot shape 3D data of a foot of a subject of measurement P using the user terminal.

FIG. 10 is a block diagram showing the configuration of a 3D sock measurement shop terminal.

FIG. 11 is a perspective view showing a method of measuring foot shape 3D data of a bare foot of a subject of measurement using a 3D scanner.

FIG. 12 is a cross-sectional view taken along the corrected instep girth with a measurement sock worn on the subject.

FIG. 13 is a flowchart showing a procedure for transmitting foot shape specification data from a 3D sock measurement shop terminal to a data server.

FIG. 14 is a perspective view showing a measurement insole.

FIG. 15 is a side view of the measurement insole placed on a sole.

FIG. 16 is a perspective view of the measurement insole being inserted into a sock.

FIG. 17 is a side view of a bare foot of a subject of measurement wearing the sock with the measurement insole inserted.

FIG. 18 is a block diagram showing the configuration of a 3D virtual insole measurement shop terminal.

FIG. 19 is a flowchart showing a procedure for transmitting foot shape specification data from the 3D virtual insole measurement shop terminal to the data server.

FIG. 20 is a block diagram showing the configuration of a manual measurement shop terminal.

FIG. 21 is a flowchart showing a procedure for transmitting foot shape specification data from the manual measurement shop terminal to the data server.

FIG. 22 is a perspective view showing a foot size measurement tool.

FIG. 23 is a perspective view showing a state of the foot size measurement tool of FIG. 22 during measurement.

FIG. 24 is a side view showing a state of the foot size measurement tool of FIG. 22 during measurement.

FIG. 25 is a plan view showing another foot size measurement tool.

FIG. 26 is a perspective view showing a first wearable element of the foot size measurement tool of FIG. 25.

FIG. 27 is a block diagram showing the configuration of a shoe last maker terminal.

FIG. 28 is a flowchart showing a procedure by a shoe last maker terminal that receives foot shape specification data from the data server.

FIG. 29 is a block diagram showing the configuration of a shoe shop terminal.

FIG. 30 is a flowchart showing the procedure for retrieving ready-made shoes with the shoe shop terminal.

FIG. 31 is a block diagram showing the configuration of the data server.

FIG. 32 is a flowchart showing a procedure of basic operations of the data server.

FIG. 33 is a flowchart showing a procedure performed when the data server generates a virtual insole.

FIG. 34 is a flowchart showing a procedure performed when the data server performs the main process of a ready-made shoe search system.

FIG. 35 is a flowchart summarizing a procedure of the entire system of the present embodiment.

FIG. 36 is a flowchart summarizing a procedure of the entire system of the present embodiment.

FIG. 37 is a flowchart showing a typical conventional process for producing custom shoes.

FIG. 38 is a side view showing an example of a foot orthosis.

FIG. 39 is a side view showing an example of a foot orthosis attached to a bare foot of a subject of measurement.

FIG. 40 is a side view showing another example of a foot orthosis attached to a bare foot of a subject of measurement.

### DESCRIPTION OF EMBODIMENTS

First Embodiment

<Outline of Present Embodiment>

Referring to an illustrative embodiment, a method for generating foot shape specification data, a method for producing shoes, a ready-made shoe search method, a custom shoe production assisting system, and a ready-made shoe search system according to the present disclosure are now described. The present inventors, who are the inventors of Patent Literatures 1 to 6, are well-versed in shoemaking techniques and have knowledge as engineers. Various attempts have been made by those skilled in the art to produce custom shoes using 3D scanners. However, none came close to produce, using 3D data and without fittings of shoes, custom shoes of the level achieved by skilled professionals. This is because, in order to produce custom shoes that are comfortable and aesthetically pleasing from 3D data obtained by measuring bare feet, the conversion of the bare foot 3D data into 3D data of shoe lasts for producing custom shoes is crucial. The present inventors have completed the technique of the present disclosure by combining the experience and expertise in shoemaking with technical analysis and knowledge.

The essence of the technical idea of the present disclosure is, typically, to generate foot shape specification data FSSD from corrected foot shape 3D data CFSD in foot measurement, and to produce comfortable custom shoes OS or select ready-made shoes RS based on the foot shape specification data FSSD. Additionally, it is also possible to manually measure foot shape specification data FSSD by actually measuring a subject of measurement P using a foot size measurement tool. Determining the features of the feet of the subject P using such foot shape specification data FSSD allows comfortable custom shoes to be produced only with the foot shape specification data FSSD of a small data size and without fittings or large 3D data obtained by 3D scanning Furthermore, the use of the foot shape specification data FSSD with a small data size allows a user and a shop that do not have equipment such as a 3D scanner to use the custom shoe production assisting system and ready-made shoe search system of the present disclosure.

<Overview of Conventional Shoemaking Process>

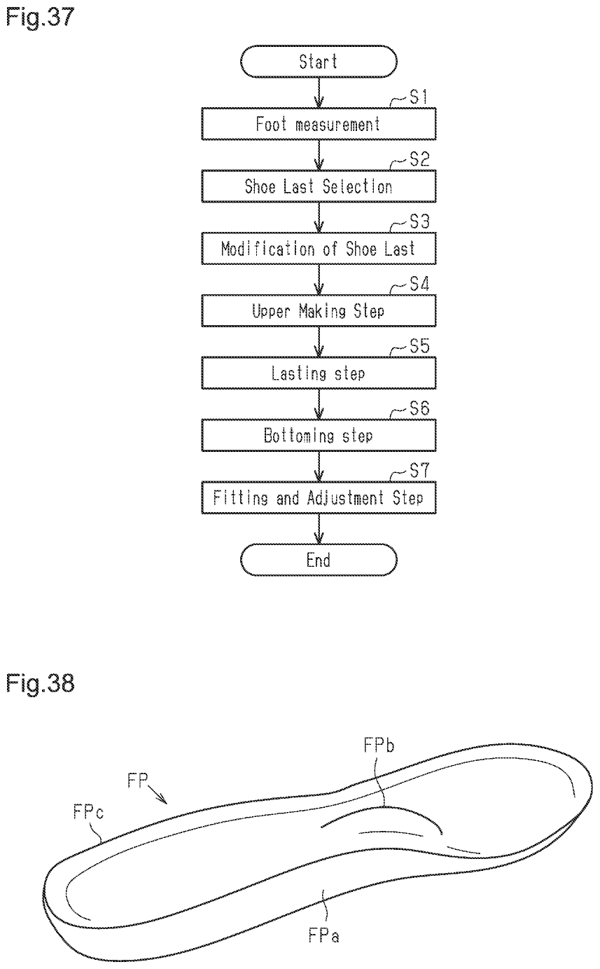

FIG. 37 is a flowchart showing a typical conventional shoemaking process for custom shoes OS. Before describing the aspects of the present disclosure, an outline of typical conventional shoemaking process for custom shoes, which forms a basis of the present disclosure, is briefly described.

<Foot Measurement (S1)>

First, an operator performs a step of measuring dimensions of a foot (S1).

The operator first measures the foot length L. The foot length L, also referred to as length, is the length from the heel point HP to the tip of toe To, that is, the tip of the longest toe, parallel to the center line C (the line connecting the center of the second toe to the heel point HP). The longest toe is the first toe for an Egyptian-type foot and the second toe for a Greek-type foot, for example. The important point is that the foot length L is the length of a line segment parallel to the center line C.

The operator also measures the foot width FW or ball girth BG.

The foot width FW refers to the width from the ball of big toe BJ (ball joint, base of big toe, or metatarsal point on tibial side) to the ball of small toe STB (small toe ball, base of small toe, or metatarsal point on fibular side).

The ball girth BG is the circumference extending over the ball of big toe BJ and the ball of small toe STB. According to the Japanese Industrial Standards (JIS), the ball girth BG is indicated by widths A to E and 2E to 6E.

<Shoe Last Selection (S2)>

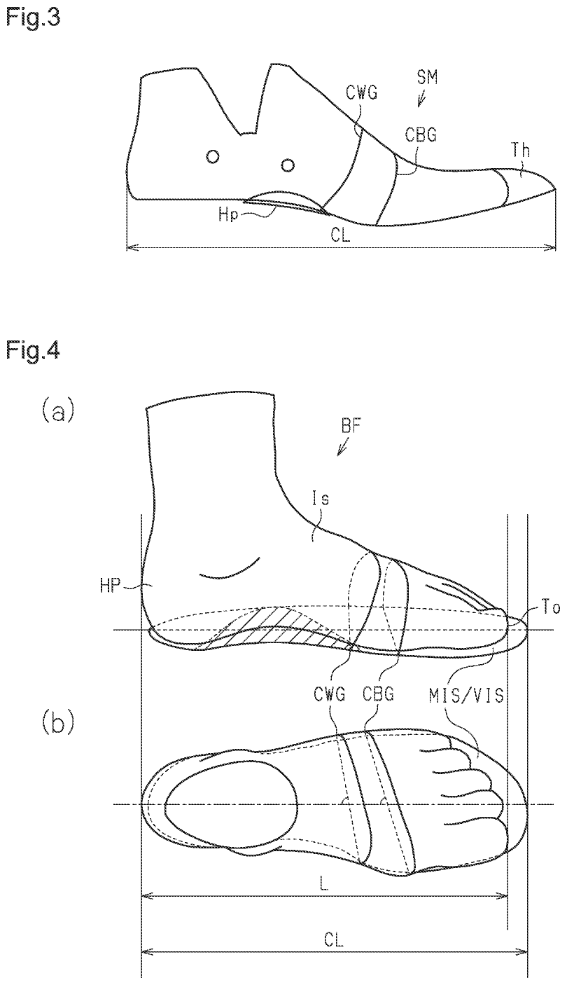

The operator then selects a ready-made shoe last SM based on the measured dimensions including the foot length L, the foot width FW or the ball girth BG, and the instep girth WG (S2). FIG. 3 shows a right side view of a shoe last SM for left foot. A shoe last SM is generally specified by foot length L and width indication, such as “25.5-EE” according to the JIS standard. When compared, the foot length CL, ball girth CBG, and instep girth CWG of the shoe last SM shown in FIG. 3 differ in value from the foot length L, ball girth BG, and instep girth WG, respectively, of the bare foot BF of the subject of measurement P. Conventionally, such individual differences in dimension are generally ignored, and the dimensions determined from the shoe maker's rule of thumb are used.

<Modification of Shoe Last (Building-up) (S3)>

The operator selects a shoe last that is slightly smaller than the size of the subject P and modifies the last by building up the ball girth BG and the instep girth WG. The extent to which the last is built up depends largely on the intuition of the skilled professional.

<Upper Making Step (S4)>

The operator then cuts leather based on a pattern corresponding to the shoe last SM, and sews the cut leather parts to create upper leather UP. This is referred to as an upper making step (S4). The upper leather UP, also referred to as an upper part or an upper, is the upper part of the shoe that is made by stitching leather and yet to be attached to a sole.

<Lasting Step (S5)>

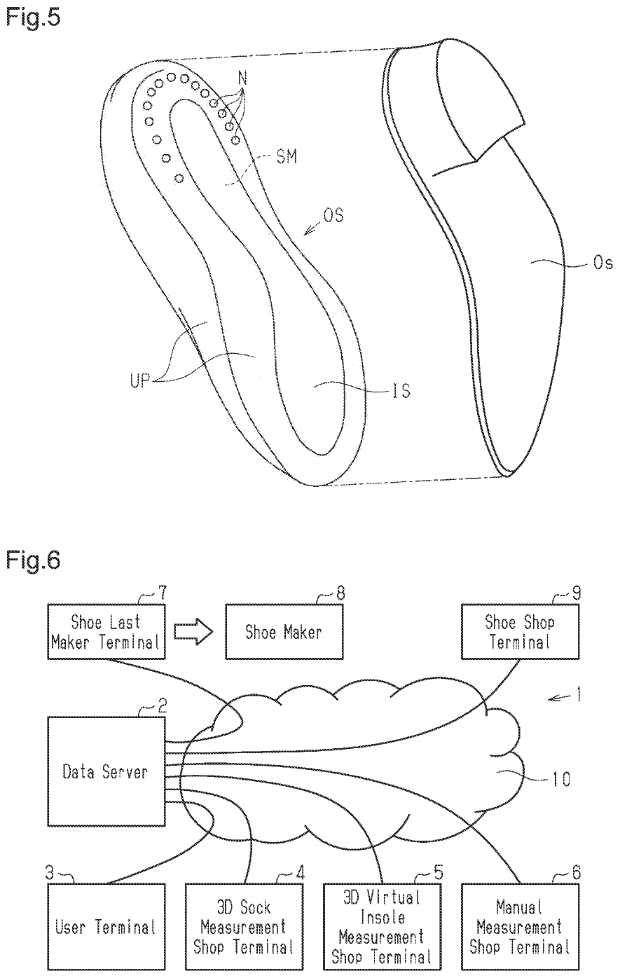

FIG. 5 is a perspective view showing a lasting step. In the lasting step, the operator attaches the upper leather UP produced in the upper making step (S4) to an insole IS temporarily fixed to the shoe last SM.

Specifically, the operator first temporarily attaches the insole IS to the upper portion of the selected shoe last SM with nails or the like. This insole IS differs from a virtual insole VIS and a measurement insole MIS, which will be described below, and forms a part of a custom shoe OS that is actually produced.

The operator inserts a toe puff or a counter stiffer into the upper leather UP produced in the upper making step (S4). The toe puff is inserted between the upper and the lining in the toe portion of the shoe. The toe puff is a member for maintaining the shape of the toe portion of the shoe and protecting the toes of the foot. A counter stiffer is a moon-shaped reinforcing member inserted between the quarter and the quarter lining in the heel portion of the shoe. The operator sets the upper leather UP, having the toe puff or the counter stiffer inserted, onto the shoe last SM on which the insole IS is set, with the bottom of the upper leather UP facing upward. Also, the operator heats and cools the upper leather UP to pull up the edge of the upper leather UP. This causes the upper leather UP to adhere to the shoe last SM and take shape. Then, as shown in FIG. 5, the operator fixes the upper leather UP to the insole IS with nails N or an adhesive (S5).

<Bottoming Step (S6)>

As shown in FIG. 5, the operator performs a bottoming step in which the upper leather UP after the lasting step is joined to an outsole Os with a bottom filler or the like sandwiched in between (S6). The outsole Os is a member that comes into contact with the ground. JIS S 5050 specifies eight types of production methods as representative bottoming methods, including Goodyear Welt process, Silhouwelt process, Stitch-down process, Mckay process, cement process, California Process, direct vulcanizing process, and injection molding process.

<Fitting and Adjustment Step (S7)>

Conventional custom shoes OS are produced by relying on the intuition of the skilled professionals or by selecting shoe lasts SM of standard sizes ignoring individual differences. For this reason, the fitting and adjustment step has been indispensable in which the subject P actually tries on the custom shoes OS before they are completed to check for any problems and to adjust the modification (portion in which the last is built up) of the shoe lasts SM in case of problems.

The conventional shoemaking process is completed through the above steps.

<Difference between Bare Foot BF and Shoe Last SM>

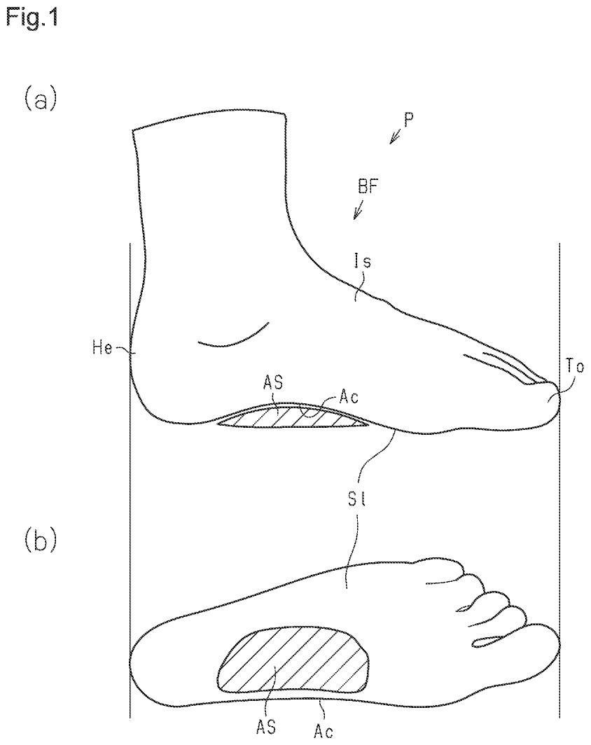

The difference between the shoe lasts SM used in the shoemaking process and the bare feet BF of a subject of measurement is now described. FIG. 1 is a diagram showing the right side of the bare left foot BF of a subject of measurement. FIG. 3 is a diagram showing the right side of a shoe last SM for left foot.

<Shape of Sole Sl>

As can be seen from the lasting step (S5) shown in FIG. 5, the shoe last SM shown in FIG. 3 basically has a shape corresponding to the internal space of a completed custom shoe OS. That is, the shape of the sole Sl (what is known as bottom of foot) of the shoe last SM is not the same as the shape of the bare foot BF shown in FIG. 1. The shape of the sole of the shoe last SM is a combination of the shape of the bare foot BF shown in FIG. 1 and a raised portion Hp corresponding to the space AS between the arch Ac and the insole IS show in FIG. 3. That is, the sole of the shoe last SM has a generally flat shape.

What is referred to as flat foot has a small or substantially no space AS under the arch Ac shown in FIG. 1. In contrast, a high-arched foot has a large arch Ac and thus a large space AS under the arch Ac. The shoe last SM is flat in shape and does not have a concave corresponding to the arch Ac. That is, the shoe last SM conforming to the JIS standard has the shape of a combination of the bare foot BF and the space AS under a substantially average arch Ac. However, in a strict sense, the shape of the shoe last SM is not the shape obtained by attaching an actual insole IS to the bare foot BF. Since an actual insole IS is thick, the shape of the shoe last SM differs from the shape of the bare foot BF to which the insole IS is added.

<Human Feet During Walking>

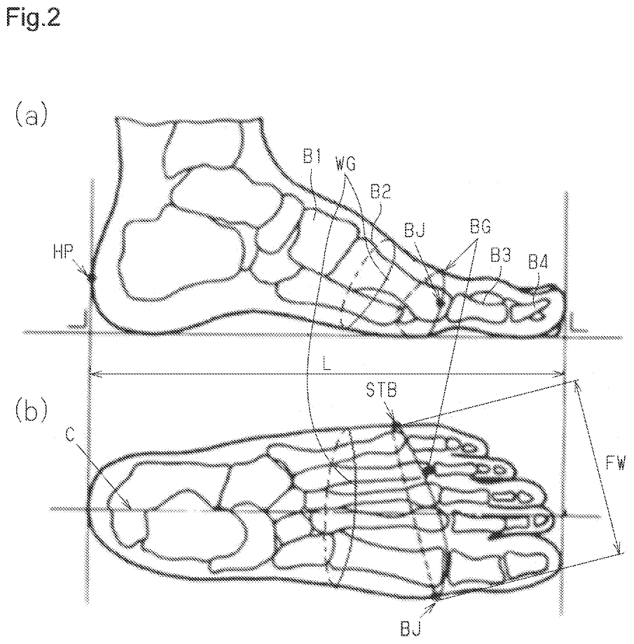

When a person walks, the feet assume different shapes. However, due to the structure of the human foot shown in parts (a) and (b) of FIG. 2, the cuneiform bone B1 in the instep of the foot hardly moves. Also, the proximal ends of the first to fifth metatarsal bones B2, which are closer to the tip of the foot than the cuneiform bone B1, move less. The first to fifth proximal phalanges B3 and the first to fifth distal phalanges B4, which are closer to the tip of the foot than the first to fifth metatarsal bones B2, move flexibly because of the gaps between them and many movable joints.

The above suggests the following two facts. First, a shoe and a foot are preferably held together at a portion near the cuneiform bone B1, which does not move, or the proximal ends of the first to fifth metatarsal bones B2, namely the instep Is shown in FIG. 1. In other words, it is desirable to hold the shoe and the foot together at the position of instep girth WG. Secondly, the distal ends of the first to fifth metatarsal bones B2, the first to fifth proximal phalanges B3, and the first to fifth distal phalanges B4, where the foot moves, should not be compressed so that they have room to accommodate the shape variation caused by walking. Compressing these portions excessively can deform the foot and cause hallux valgus or bunionette.

<Instep Girth WG>

A custom shoe OS and a bare foot BF are preferably held together at a portion where the foot does not move. That is, in general, a custom shoe OS can be stably held to a foot when fitted to the instep Is of the subject of measurement P. In other words, the custom shoe OS is preferably held on the foot at the position of instep girth WG. This has been demonstrated in the verification performed by the inventors over more than a decade.

As described above, for conventional custom shoes OS, the foot length L shown in part (b) in FIG. 2 and the ball girth BG over the ball of big toe BJ and the ball of small toe STB shown in part (a) in FIG. 2 are measured. In some cases, the instep girth WG, which is the circumference over the instep Is, is also measured. However, as shown in part (a) in FIG. 2, the instep girth WG does not include the space AS under the arch Ac shown in FIG. 1. As such, with a severe case of flat foot, the absence of the arch Ac causes the instep girth WG to be equal to the circumference at the instep Is of a custom shoe OS. However, for a high arch (when the space AS under the arch Ac is large), when the instep girth WG is equal to the circumference of the instep Is of a custom shoe OS, this custom shoe OS is too small in size. Thus, the same instep girth WG may require different custom shoes OS for a good fit. For this reason, shoes have conventionally been produced by including a standard space AS as the space AS.

<Difference Between Present Embodiment and Conventional Technique>

In recent years, a 3D scanner has been used to identify the shape of a bare foot BF of a subject of measurement P. However, the measurement is performed with the sole Sl in contact with the ground, typically failing to measure the correct shape of the arch Ac of the subject. The shape of a bare foot BF can also be 3D scanned with the foot placed on a transparent board or suspended in the air. However, measuring for the shoemaking purpose would be meaningless unless the shape of the bare foot BF is measured under a load.

The present inventors have found that, to produce comfortable custom shoes OS, it is important to reproduce the internal space of the custom shoes OS, instead of simply reproducing the shape of the feet of the subject P. In other words, the inventors have created the idea of foot shape specification data FSSD to determine the shape a shoe last SM from a bare foot BF so as to easily produce a custom shoe OS that fits well while having flexibility in design and offering the best comfort for the shape of the bare foot BF of the subject P.

The fundamental technical idea of the present disclosure is that, on the premise that the corrected foot length CL matches, determining the corrected instep girth CWG forms a shoe that is stably fixed to the foot regardless of the specific shape of the shoe. A permissible range is set for the matching of the corrected foot length CL. The corrected ball girth CBG may deviate within a permissible range that does not cause the shoe to be too tight. The corrected instep girth CWG may also deviate within a permissible range that does not cause the shoe to be too tight, but this range is smaller than the range for the corrected ball girth CBG.

<Calculation of Foot Shape Specification Data FSSD of Present Embodiment>

The Foot shape specification data FSSD is based on the idea of reproducing the space AS based on a measurement insole MIS or a virtual insole VIS and calculating a corrected instep girth CWG including the space AS in measurement.

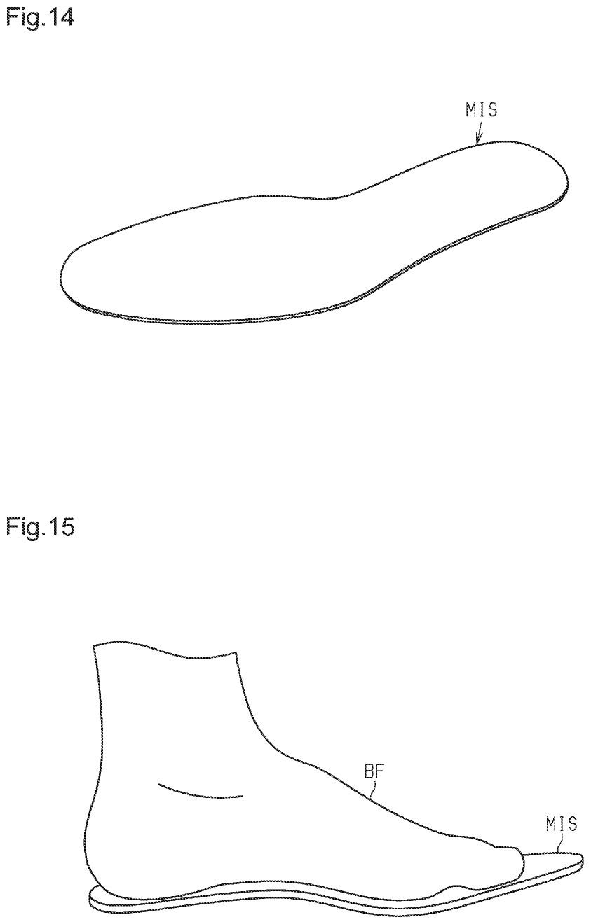

To this end, one method uses a measurement insole MIS shown in FIGS. 14 and 15 to reproduce the space AS. The measurement insole MIS is physically tangible and made of plastic or the like. Measurement is manually performed with this measurement insole MIS positioned on the sole SI of a foot of a subject of measurement P.

The measurement insole MIS can be fixed to the sole Sl with an adhesive, double-stick tape, single-stick tape, or the like.

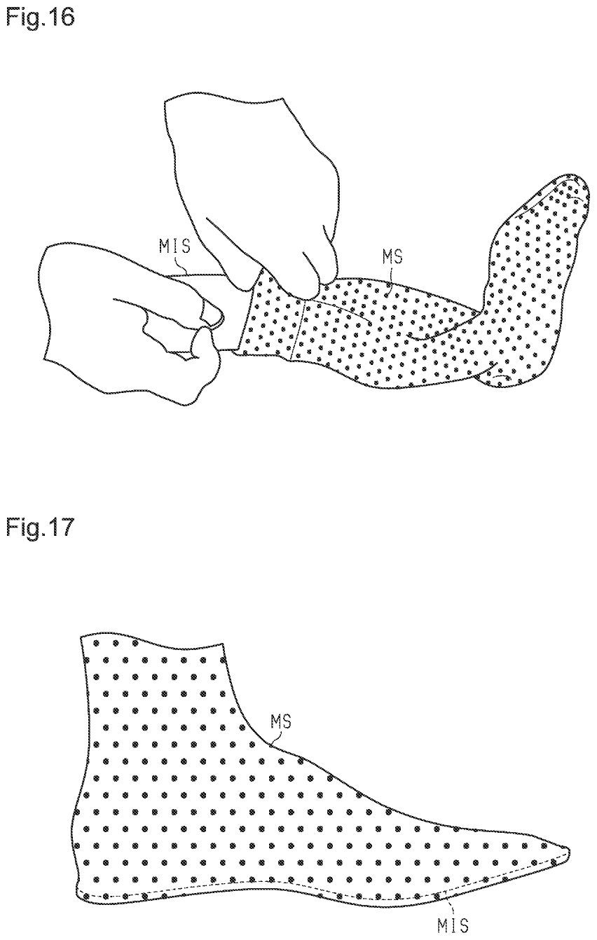

In the sock measurement method shown in FIGS. 16 and 17, the measurement insole MIS is inserted into a measurement sock MS and then fixed in place. This allows the measurement sock MS to form a surface at the opening section of the space AS. When worn by the subject of measurement, the measurement sock MS causes the foot wearing the sock MS to resemble the shape of a shoe last SM in a simple, reliable manner.

FIGS. 22 to 24 show a foot size measurement tool 601 including a measurement insole MIS integrated with the foot size measurement tool 601. The foot size measurement tool 601 enables the calculation of “foot shape specification data FSSD”.

Furthermore, a 3D scanner may be used to easily obtain foot shape 3D data FD3D, which represents the three-dimensional shape of the bare foot BF of the subject P. This foot shape 3D data FD3D may be subjected to data processing to generate a further suitable virtual insole VIS. Additionally, combining the foot shape 3D data FD3D and the virtual insole VIS on the data generates corrected foot shape 3D data CFSD. On the corrected foot shape 3D data CFSD, predefined dimensions, such as at least one of corrected foot length CL, corrected ball girth CBG, and corrected instep girth CWG, are measured to calculate the foot shape specification data FSSD. This method performs all measurements through data processing, allowing the foot shape specification data FSSD to be calculated without using a measurement insole MIS.

The shape of the measurement insole MIS and the shape of the virtual insole VIS are substantially the same.

The above measurement methods will be described in detail below.

<Toe Room Th>

The internal space of a shoe requires room for the movable portion of the foot to change shape during walking. For this reason, the distal end portion of the shoe last SM has a toe room Th. The toe room Th is an allowance dimension that is set taking into consideration the deviation between the shoe size and the foot size resulting from the foot flexing while walking. This allowance is necessary because the tip of the foot is shifted forward in the shoe while walking (when flexing). The shoe last SM shown in FIG. 3 has a toe To longer than that of the bare foot BF shown in FIG. 1 by the toe room Th. Accordingly, the foot length CL of the shoe last SM is longer than the foot length L shown in FIG. 2.

The suitable toe room Th varies depending on the type and design of the shoe. Custom leather shoes OS for business may have relatively large toe room Th, not only to merely secure room for the toes, but also to facilitate the leather processing and aesthetically improve the shoe shape, or because they typically have toe puffs to protect the toes To.

Configuration of Present Embodiment

Referring to FIGS. 6 to 36, the present embodiment is now described.

<System of Present Embodiment>

As shown in FIG. 6, the present embodiment has a system 1 including computers. The system 1 is a custom shoe production assisting system that assists custom shoe production in which custom shoes OS are produced using shoe lasts SM. The system 1 also serves as a ready-made shoe search system.

A data server 2, which is a server computer, is connected to and communicates with a communication network 10, such as the Internet or a telephone line.

A user terminal 3 is a computer used by a subject of measurement P. Predetermined application programs are downloaded to the user terminal 3. The user terminal 3 is used as a client computer of the data server 2.

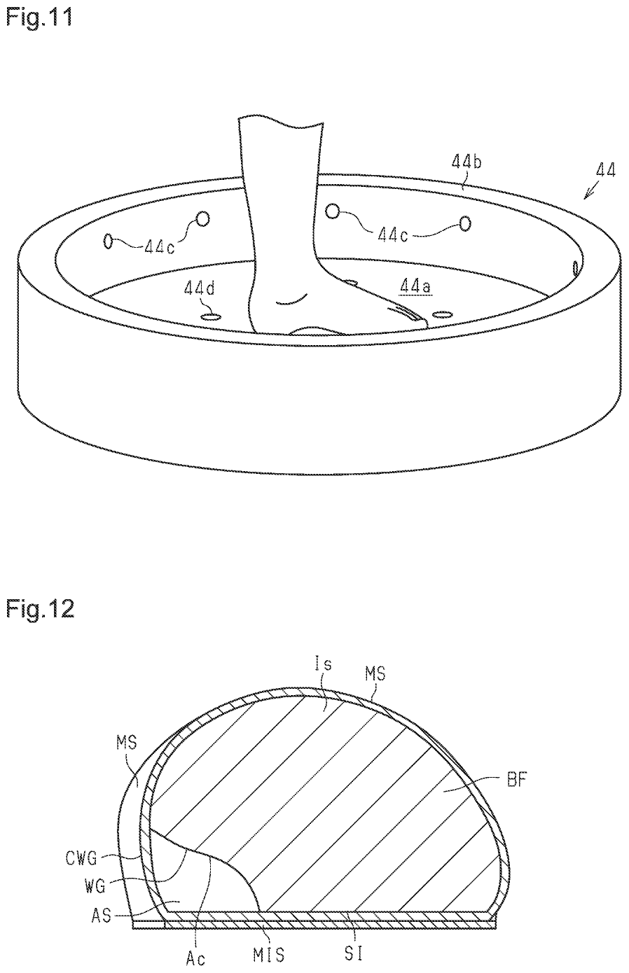

A 3D sock measurement shop terminal 4 has a 3D scanner 44 (see FIG. 11) in the shop, and is capable of performing a measurement method using measurement socks MS (see FIGS. 14 to 17). The terminal 4 can be used to measure the feet of a subject of measurement P visiting the shop, or to collect 3D data using the 3D scanner 44. The terminal 4 can also generate foot shape specification data FSSD and transmit the generated data FSSD to the data server 2. A 3D virtual insole measurement shop terminal 5 includes a 3D scanner (54) similar to that of the terminal 4. The terminal 5 can be used to perform measurement using virtual insoles VIS (see FIG. 4) and measurement using measurement insoles MIS (see FIG. 15).

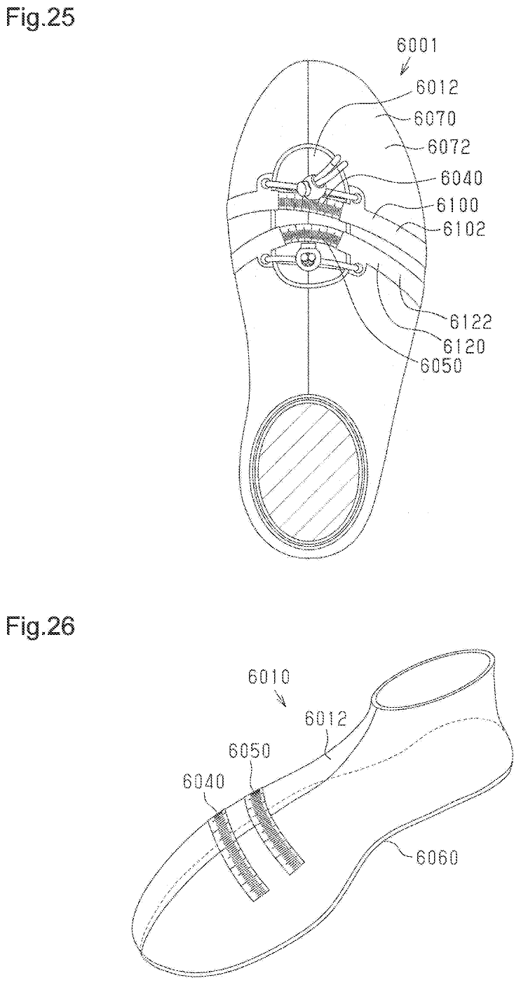

When a manual measurement shop terminal 6 is used, the feet of the subject P are measured using a specialized foot size measurement tool 601 (see FIG. 22 to 24) or 6001 (see FIGS. 25 and 26). Then, the terminal 6 can generate foot shape specification data FSSD and transmit the generated foot shape specification data FSSD to the data server 2.

The user terminal 3 and the shop terminals 4, 5, and 6 are foot shape specification data provider terminals. These terminals 3, 4, 5, and 6 transmit at least the foot shape specification data FSSD to the data server 2. Based on this foot shape specification data FSSD, the data server 2 generates data for selecting and producing shoe lasts SM. The data server 2 can also provide the foot shape specification data FSSD to a shoe last maker terminal 7 as a foot shape specification data provider terminal.

The shoe last maker terminal 7 receives the foot shape specification data FSSD and the like from the data server 2, and produces shoe lasts SM based on the received foot shape specification data FSSD.

A shoe maker 8 produces custom shoes OS based on the shoe lasts SM produced by the shoe last maker.

A shoe shop terminal 9 transmits ready-made shoe shape data RSSD handled by the shop to the data server 2 in advance. The data server 2 accumulates the received data RSSD. The data server 2 compares the foot shape specification data FSSD of the subject P with the accumulated ready-made shoe shape data RSSD, and retrieves and selects ready-made shoes RS of similar shapes. The shoe shop terminal 9 presents the subject P with the retrieved and selected ready-made shoes RS. The shoe shop terminal 9 may be used as a 3D sock measurement shop terminal 4, a 3D virtual insole measurement shop terminal 5, or a manual measurement shop terminal 6 for receiving orders for custom shoes OS.

The system 1 shown in FIG. 6 is an example for explanation, and various other combinations may also be contemplated.

<User Terminal 3>

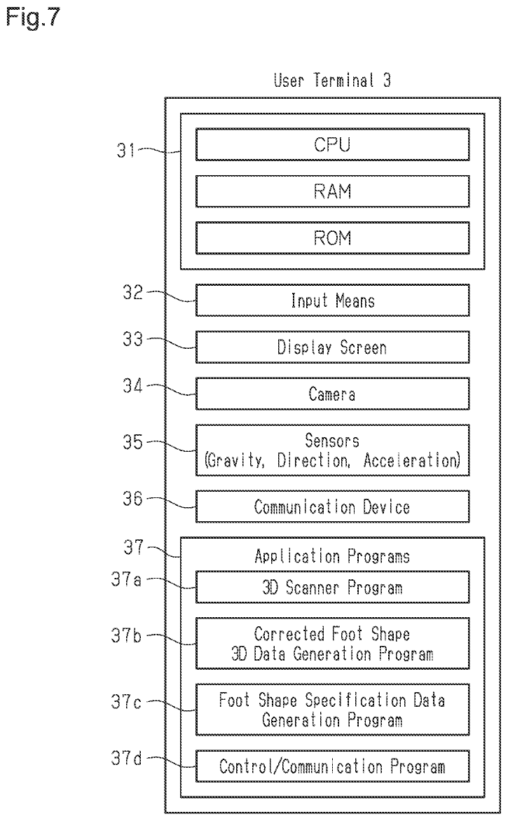

The user terminal 3 shown in FIG. 7 may be a smartphone, such as Apple's “iPhone (registered trademark)”, for example. A smartphone is a mobile phone terminal including a computer 31 having a CPU, RAM, and ROM. For example, the terminal 3 may include an input means 32, a display screen 33, a camera 34, one or more sensors 35, a communication device 36, and application programs 37.

The display screen 33 may be a liquid crystal display, for example. The display screen 33 may be the input means 32 configured as a touch panel. The camera 34 can integrate data that is continually captured. The one or more sensors 35 may include a gravity sensor, a magnetic orientation sensor, or a three-dimensional acceleration sensor, for example, and are used to identify the position, direction, and orientation of the user terminal 3.

A 3D scanner program 37a, which is an application program 37, is downloaded to and stored in the user terminal 3. This allows the user terminal 3 to be used as a handheld 3D scanner. In this case, a technique of photogrammetry, which creates a 3D model from still images captured at different angles, can be used. A known technique, such as one described in Patent Literature 9, may be used for a 3D scanner using a smartphone. Specific examples include RECAP (registered trademark) sold by Autodesk Inc., Qlone 3D Scanner (registered trademark) developed by EyeCue Vision Technologies LTD, 3D Scanner Pro announced by Laan Labs, and Trnio Inc. by Trnio Inc.

The user terminal 3 also has a corrected foot shape 3D data generation program 37b, which is an application program that generates a virtual insole VIS from 3D-scanned foot shape 3D data FD3D and generates corrected foot shape 3D data CFSD.

The user terminal 3 further includes a foot shape specification data generation program 37c, which generates, from the generated corrected foot shape 3D data CFSD, foot shape specification data FSSD including predefined dimensions such as at least one of corrected foot length CL, corrected ball girth CBG, and corrected instep girth CWG.

The user terminal 3 has a control and communication program 37d, which controls the series of above operations and communicates with the data server 2.

<Procedure With User Terminal 3>

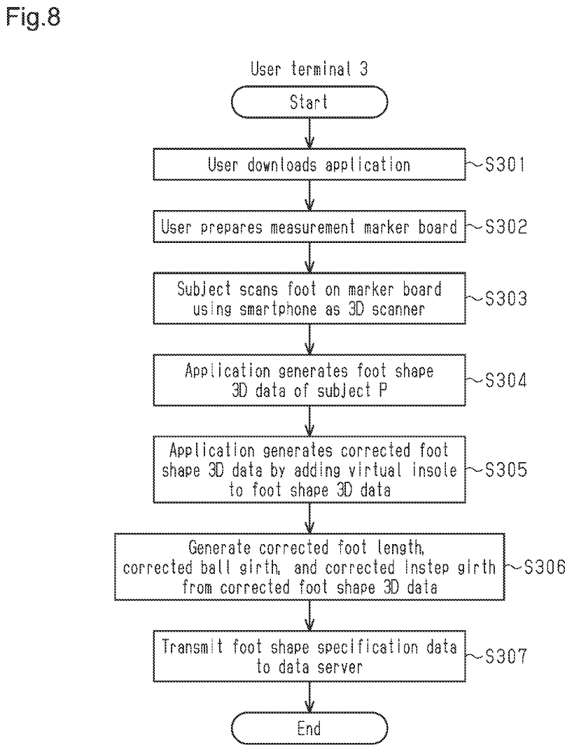

FIG. 8 is a flowchart showing a procedure for transmitting foot shape specification data FSSD from the user terminal 3 to the data server 2. The user terminal 3 configured as described above transmits foot shape specification data FSSD to the data server 2 in the following procedure.

First, the user who is a subject of measurement P downloads and installs an application from a predetermined website in advance (S301). The user also prepares a marker board 38 for measurement by receiving an actual board or by downloading data from the Internet and printing it, for example (S302).

After these are prepared, the subject uses a smartphone as a 3D scanner to scan the foot on the marker board (S303).

<3D Scan With User Terminal 3>

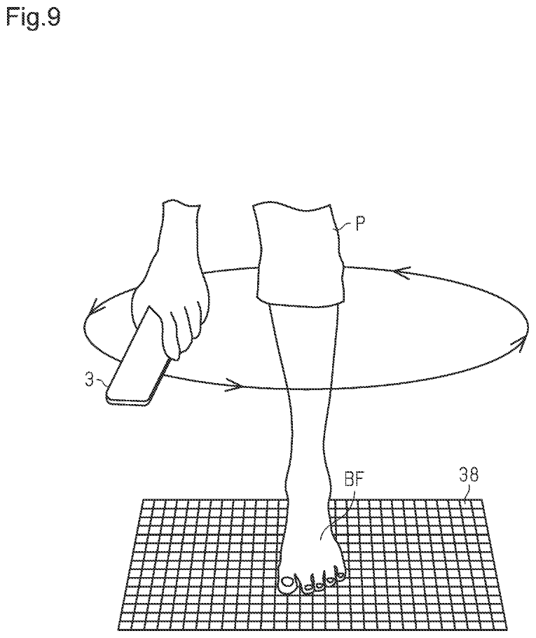

FIG. 9 shows an example of a method of measuring foot shape 3D data FD3D of a bare foot BF of the subject P using the user terminal 3. First, the marker board 38 required for 3D scanning is prepared. The marker board 38 has various types of markers recognizable by the camera 34 printed at predetermined positions. While the camera 34 of the user terminal 3 is capturing images, the sensors 35 identify the position, direction, and orientation of the user terminal 3. The use of the marker board 38 allows the position, direction, and orientation of the user terminal 3 to be corrected to increase the accuracy, with the markers used as the reference points. This increases the accuracy in identifying the three-dimensional shape.

For measurement, the marker board 38 is first placed on a horizontal area, and the subject P is positioned the bare foot BF on the marker board 38 at a predetermined position. When the subject P starts the 3D scanner program 37a of the user terminal 3 and directs the camera 34 to the bare foot BF of the subject P, the 3D scanner program 37a recognizes the identification markers on the marker board 38. Then, using the smartphone as a 3D scanner, the subject P captures images by rotating the smartphone 360 degrees around the foot over the marker board 38, capturing an image from a horizontal direction or from above, for example.

At this time, the application downloaded to the smartphone may provide guidance for proper scanning That is, in the present embodiment, the 3D scanner program 37a superimposes, on the captured bare foot BF on the display screen 33, a dome-shaped image around the foot indicating the captured area using augmented reality (AR), for example. The subject P obtains images of the foot from all directions by capturing the area around the bare foot 360 degrees along the dome-shaped indicator following the guidance on the screen. The foot shape 3D data FD3D is easily obtained in this manner. This completes the required scanning (S303).

Then, the application performs a three-dimensional survey using the markers on the marker board 38 as reference, and models the surface of the bare foot BF with polygons. The modeled 3D model forms curved surfaces with freeform surfaces, such as NURBS curves, spline curves, and Bezier curves, to generate foot shape 3D data FD3D. Rendering may also be performed to display the cFD3D of the subject P on the display screen of the user terminal (S304).

Based on this foot shape 3D data FD3D, the application adds a virtual insole VIS to generate corrected foot shape 3D data CFSD (S305). This step may be performed by the smartphone, or data may be sent to and processed by the data server 2 as a cloud server. In the present embodiment, the user terminal 3 performs the processing. The application obtains the foot length L and the ball girth BG from the obtained foot shape 3D data FD3D. The application then selects the 3D data of the corresponding virtual insole VIS from the stored virtual insole VIS data. Then, as shown in part (a) and part (b) in FIG. 4, the application aligns the sole Sl of the foot shape 3D data FD3D with the center line C of the virtual insole VIS and positions the virtual insole VIS on the sole Sl of the foot shape 3D data FD3D. In the same manner as the measurement insole MIS shown in FIG. 12, the application generates a 3D model forming a surface that closes the space AS between the arch Ac and the virtual insole VIS to generate corrected foot shape 3D data CFSD.

The application (user terminal 3) measures and obtains a corrected foot length CL, a corrected ball girth CB G, and a corrected instep girth CWG from the corrected foot shape 3D data CFSD generated by integrating the virtual insole VIS and the foot shape 3D data FD3D as described above (S306). The user terminal 3 transmits foot shape specification data FSSD to the data server 2 via the communication network 10 (S307). This completes the procedure for transmitting the foot shape specification data FSSD from the user terminal 3 to the data server 2 (End).

In the present embodiment, the user terminal 3 performs the 3D modeling process from S304 by itself. However, depending on the processing capability, storage capacity, communication environment, and the like of the user terminal 3, the data server 2 may perform processing as a cloud server in place of the user terminal 3. In this case, the user terminal 3 transmits the foot shape 3D data FD3D to the data server 2, and the data server 2 performs all the processing from S304.

<3D Sock Measurement Shop Terminal 4>

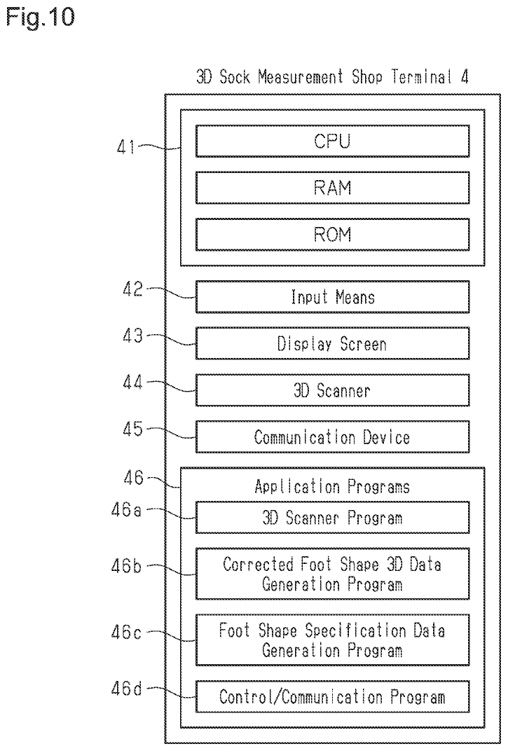

FIG. 10 shows the configuration of the 3D sock measurement shop terminal 4. The 3D sock measurement shop terminal 4 generates foot shape specification data FSSD using a measurement sock MS including a measurement insole MIS. The 3D sock measurement shop terminal 4 is a client computer terminal. The terminal 4 is a client computer terminal including a specialized stationary 3D scanner 44 and a computer 41 having a CPU, RAM, and ROM. The terminal 4 may also include an input means 42, a display screen 43, the 3D scanner 44, a communication device 45, and application programs 46.

For example, the display screen 43 may be a liquid crystal display, and the input means 42 may be at least one of a keyboard and a mouse.

FIG. 11 shows an example of a method of measuring a bare foot BF of a subject of measurement P using the 3D scanner 44 to obtain foot shape 3D data FD3D. The 3D scanner 44 is typically a known 3D scanner, such as the ones described in Patent Literatures 7 and 8. The illustrative 3D scanner 44 of the present embodiment includes a horizontal footrest 44a, which is made of transparent glass and on which the bare foot BF of the subject P is placed, a side wall 44b extending from the outer circumference of the footrest 44a so as to surround the bare feet BF, and multiple cameras 44c arranged in the side wall 44b. The scanner 44 also has a camera 44d under the footrest 44a. The 3D scanner 44 captures the shape of the foot of the subject P placed on the footrest 44a with the cameras 44c and 44d and generates foot shape 3D data FD3D using the photogrammetry technique. The camera 44d under the footrest 44a can capture the shape of the sole Sl. The scanner 44 may have a single camera 44c that moves around the foot to capture multiple images.

This 3D sock measurement shop terminal 4 stores a 3D scanner program 46a, which is a downloaded application program 46. The computer 41 generates a 3D model by photogrammetry from the still images captured at multiple angles by controlling the 3D scanner 44.

The application programs 46 also include a corrected foot shape 3D data generation program 46b, which is an application program for generating corrected foot shape 3D data CFSD. The 3D data CFSD is generated based on the images obtained by 3D scanning the foot of the subject P wearing the measurement sock MS.

The application programs 46 include a foot shape specification data generation program 46c, which generates foot shape specification data FSSD from the generated corrected foot shape 3D data CFSD. The foot shape specification data FSSD includes predefined dimensions, such as at least one of corrected foot length CL, corrected ball girth CBG, and corrected instep girth CWG.

The application programs 46 include a control and communication program 46d, which controls the series of above operations and communicates with the data server 2.

<Principle of Sock Measurement Described in Patent Literature 6>

The 3D sock measurement shop terminal 4 performs 3D sock measurement. The present inventors have proposed a foot size measurement tool using measurement socks in Patent Literature 6.

As described above, measuring a bare foot BF does not result in the selection of a suitable shoe last SM. This is because of the lack of inclusion of the space AS under the arch Ac. In this respect, the present inventors have proposed a measuring method using a foot size measurement tool 6001 disclosed in Patent Literature 6 mentioned above. This method involves taking measurements with a specialized measurement sock MS worn on the foot. This measuring method is the same as the present disclosure in that it reproduces the internal shape of a custom shoe OS to be produced.

In summary, the foot size measurement tool 6001 includes a first wearable element 6010 having a bottom plate 6060 and a cover 6012 as shown in FIG. 26. The bottom plate 6060 corresponds to the measurement insole MIS of the present embodiment. In the method disclosed in Patent Literature 6, the lengths of the ball girth BG and the instep girth WG are manually measured while the first wearable element 6010 is worn on the foot.

<Principle of Sock Measurement of Present Embodiment>

In the present embodiment, the corrected foot shape 3D data CFSD is obtained by wearing a measurement sock MS similar to the first wearable element 6010 and performing scanning with a 3D scanner. The method of the present disclosure differs from the conventional method in that foot shape specification data FSSD is generated from the obtained corrected foot shape 3D data CFSD. The foot shape specification data FSSD includes predefined dimensions, such as corrected foot length CL, corrected ball girth CBG, and corrected instep girth CWG.

As shown in FIG. 12, a subject of measurement P wears a measurement sock MS on a bare foot BF. This measurement sock MS has a measurement insole MIS arranged so as to come into contact with the sole SI of the subject P. The measurement sock MS does not come into close contact with the bare foot BF, forming a space AS between the arch Ac and the measurement insole MIS. In this state, the outer circumference and the corrected instep girth CWG of the measurement sock MS are measured. This corrected instep girth CWG is larger in value than the instep girth WG of the bare foot BF. Since the measurement sock MS can stretch, the corrected instep girth CWG represents a state in which the measurement sock MS fits the instep Is of the subject P. Selecting a shoe last SM based on the corrected instep girth CWG ensures that a custom shoe OS that fits the instep Is of the subject P is produced.

<Measurement With 3D Sock Measurement Shop Terminal 4>

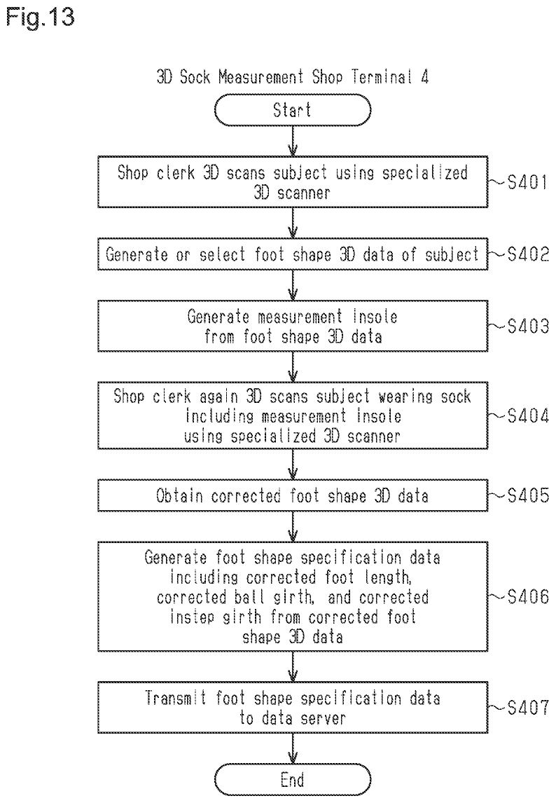

As shown in FIG. 13, the terminal 4 performs 3D measurement by applying the principle of the above-described sock measurement.

First, a shop clerk uses the specialized 3D scanner 44 to perform 3D scanning of a bare foot BF of a subject of measurement P (S401). This scanning is a process for selecting a suitable measurement insole MIS. The terminal 4 then generates foot shape 3D data FD3D of the subject P (S402). The terminal 4 generates a measurement insole MIS as shown in FIG. 14 from the foot shape 3D data FD3D (S403). The measurement insole MIS represents the shape of the surface of the actual insole IS of a completed custom shoe OS that comes in contact with the sole SI of the subject P. The measurement insole MIS is thin to avoid measurement errors. The measurement insole MIS may be made of hard plastic that is not easily deformed.

Instead of measuring with a 3D scanner, the foot length L and the ball girth BG or the foot width FW may be measured manually with a tape measure or the like, or a standardized ready-made measurement insole MIS may be selected.

Then, the subject P wears the measurement sock MS containing the measurement insole MIS, and the shop clerk again performs 3D scanning with the specialized 3D scanner (S404). The measurement insole MIS may be fixed at a specified position on the sole Sl of the subject P as shown in FIG. 15 using adhesive tape, for example. Alternatively, as shown in FIG. 16, to avoid displacement or creation of gaps, the measurement insole MIS may be inserted into the measurement sock MS in advance, and then the subject P may wear the measurement sock MS. As shown in FIG. 17, this allows the measurement insole MIS to be attached in place, and also forms the surface covering the space AS. The absence of gaps eliminates the need for post-processing of the data after 3D scanning In this state, the terminal 4 obtains corrected foot shape 3D data CFSD (S405).

As shown in FIG. 17, the surface of the measurement sock MS may have a large number of markers that can be easily recognized by the 3D scanner 44. A large number of dots shown in FIG. 17 are examples of the markers. The terminal 4 generates foot shape specification data FSSD including a corrected foot length CL, a corrected ball girth CBG, and a corrected instep girth CWG from the corrected foot shape 3D data CFSD (S406). Then, the terminal 4 transmits the foot shape specification data FSSD to the data server 2 via the communication network 10 (S407). This completes the process with the 3D sock measurement shop terminal 4 (End).

<3D Virtual Insole Measurement Shop Terminal 5>

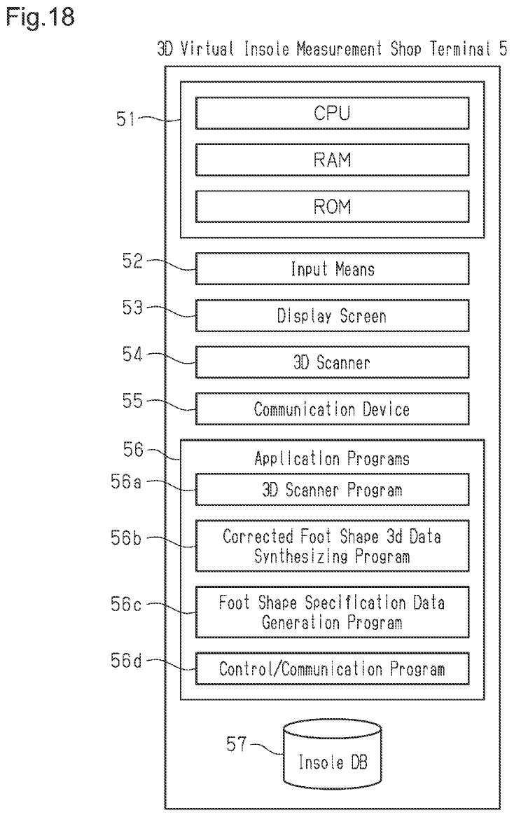

As shown in FIG. 18, the 3D virtual insole measurement shop terminal 5 is a client computer terminal including a specialized stationary 3D scanner 54. The 3D virtual insole measurement shop terminal 5 includes a computer 51 having a CPU, RAM, and ROM. The terminal 5 may also include an input means 52, a display screen 53, the 3D scanner 54, a communication device 55, application programs 56, and an insole DB 57.

For example, the display screen 53 may be a liquid crystal display, and the input means 52 may be at least one of a keyboard and a mouse. The terminal 5 includes a 3D scanner similar to that of the terminal 4. The terminal 5 has software similar to that of the user terminal 3.

The terminal 5 differs from the terminal 4 in that the virtual insole VIS is used to generate foot shape specification data FSSD. That is, the terminal 5 virtually generates foot shape specification data FSSD in a similar manner as the user terminal 3 without using a measurement sock MS or a measurement insole MIS.

The use of the specialized 3D scanner allows the terminal 5 to collect more accurate data than the user terminal 3, which is a smartphone. Also, the terminal 5 has the computer 51 with greater processing capability than a smartphone and is thus capable of more accurate measurement and faster data transmission than the user terminal 3.

When the terminal 5 is used, it is not necessary to prepare a measurement sock MS or a measurement insole MIS. Measurement can be performed only by installing application programs. Furthermore, operations by a shop clerk, such as placing a measurement sock MS and setting a measurement insole MIS, are not required, thereby avoiding measurement variations, which would otherwise occur due to the levels of work proficiency.

<Measurement With 3D Virtual Insole Measurement Shop Terminal 5>

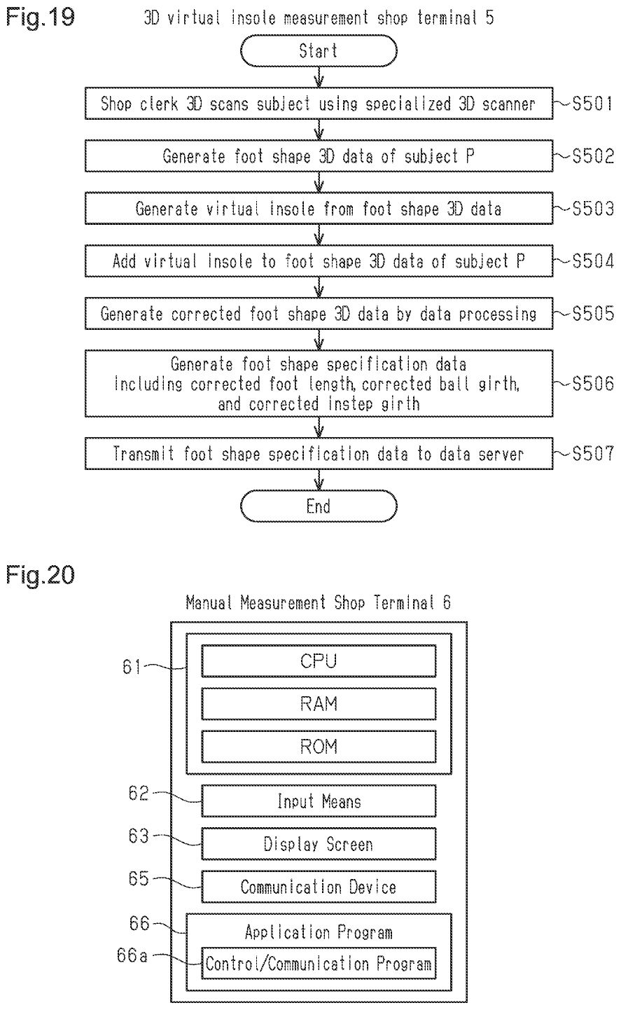

FIG. 19 shows a procedure for transmitting foot shape specification data FSSD from the terminal 5 to the data server 2 via the communication network 10.

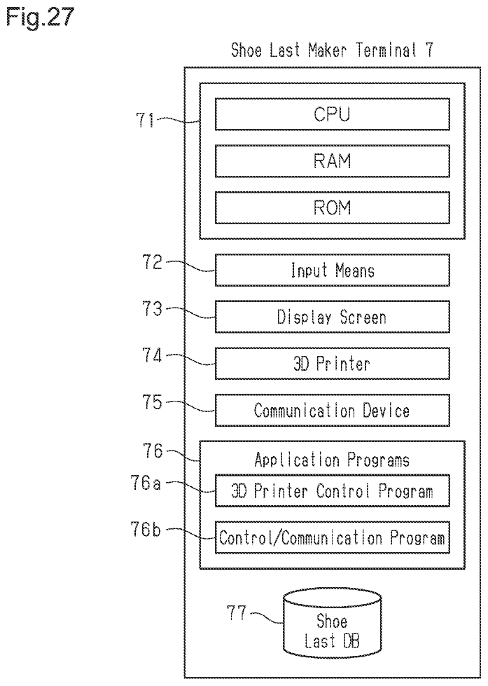

First, a shop clerk 3D scans a foot of a subject of measurement P using a specialized 3D scanner (S501). Based on the data obtained by scanning, the terminal 5 generates foot shape 3D data FD3D of the subject P (S502). The terminal 5 generates a virtual insole VIS from the foot shape 3D data FD3D (S503). Specifically, the terminal 5 selects a pattern of virtual insole VIS data from the insole DB 57 based on the foot length L and the foot width FW or the ball girth BG. When an original shoe last SM is to be eventually produced using a 3D printer (see FIG. 27) or the like, the shoe last SM has flexibility in design. In this case, the terminal 5 may determine an original virtual insole VIS from the parting line (outermost line) using AI, for example. When a shoe last SM of a certain pattern is to be used, the terminal 5 may generate and record modification data.

The terminal 5 generates a 3D model by adding the virtual insole VIS to the foot shape 3D data FD3D of the subject P (S504). The terminal 5 performs data processing to generate corrected foot shape 3D data CFSD (S505). The terminal 5 generates foot shape specification data FSSD of the generated corrected foot shape 3D data CFSD (S506), and transmits the foot shape specification data FSSD to the data server 2 (S507). The foot shape specification data FSSD includes a corrected foot length CL, a corrected ball girth CBG, and a corrected instep girth CWG, for example. In this case, the corrected foot shape 3D data CFSD generated by the terminal 5 may be transmitted as it is. This allows the data server 2 to modify details of the shoe last SM, such as for hallux valgus, bunionette, or the heel angle.

These processes may be partly performed by the cloud server in the same manner as the user terminal 3. For example, the terminal 5 may perform all the processing, or the terminal 5 may perform only minimum processing.

<Manual Measurement Shop Terminal 6>

FIG. 20 shows the configuration of the manual measurement shop terminal 6. The manual measurement shop terminal 6 is a client computer terminal and includes a computer 61 having a CPU, RAM, and ROM. The terminal 6 may also include an input means 62, a display screen 63, a communication device 65, and an application program 66.

For example, the display screen 63 may be a liquid crystal display, and the input means 62 may include at least one of a keyboard and a mouse. The application program 66 includes a control and communication program 66a for accessing the data server 2.

A manual measurement shop generally does not have a 3D scanner. The terminal 6 is installed in a manual measurement shop. The manual measurement shop terminal 6 has a computer system as a client terminal capable of transmitting information to the data server 2.

<Manual Measurement>

The present embodiment is characterized in that it transmits foot shape specification data FSSD to the data server 2 to produce custom shoes OS using suitable shoe lasts SM. What is important in this embodiment is that, instead of measuring a bare foot of a subject of measurement P with a 3D scanner, a corrected foot length CL, a corrected ball girth CBG, and a corrected instep girth CWG are correctly calculated to produce custom shoes OS or select ready-made shoes RS based on the calculated values. With the system 1 of the present embodiment, the key data for determining the shape of the foot of the subject P is the foot shape specification data FSSD. The data of particular importance in the foot shape specification data FSSD is the corrected instep girth CWG. For this reason, generating the foot shape specification data FSSD using a 3D scanner is advantageous in generating the foot shape specification data FSSD as the key data for determining the shape of the foot of the subject P. It is further advantageous when the system 1 is used with the corrected instep girth CWG as the main data. The most important point is that the foot shape specification data FSSD determining the foot size of the subject P can be sent to data server 2 even from the manual measurement shop terminal 6.

In addition to the user terminal 3, the 3D sock measurement shop terminal 4, and the 3D virtual insole measurement shop terminal 5, the manual measurement shop terminal 6 also corresponds to the foot shape specification data provider terminal of the present disclosure.

<Manual Measurement With Collapsible Foot Size Measurement Tool>

FIG. 22 shows a foot size measurement tool 601 disclosed in Patent Literature 3. A measurement tool main body 601A includes a foot pattern indication portion 610. A string-shaped measure portion 6240 extends from two holes opening in a ball girth measurement portion 640 to opposite sides in width directions. A measure portion 6250 extends from two holes opening in an instep girth measurement portion 650 in width directions. The foot size measurement tool 601 includes a heel rest portion 670 in the heel section. The heel rest portion 670 is a triangular case having an inclined plate portion 674, a vertical plate portion 676, and a horizontal plate portion 678. The triangular case has a triangular cross-section that is uniform in the axial direction. The heel rest portion 670 further includes vertical plate portions 680 and 682 intersecting the plate portions 674, 676, 678 so as to sandwich the heel in the width direction. The vertical plate portion 676 is used as a wall surface against which the heel rests.

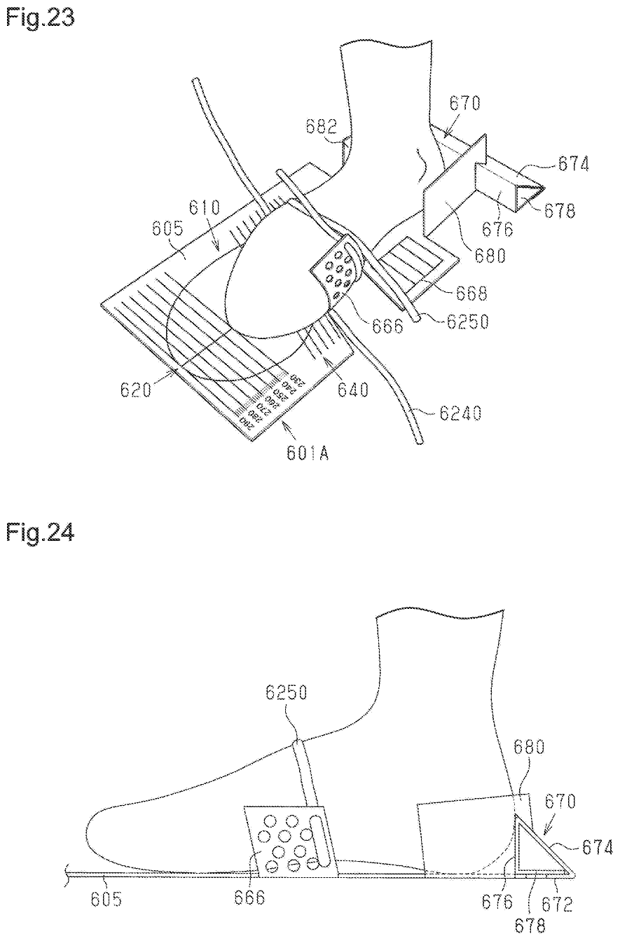

FIG. 23 shows how the foot size measurement tool 601 is used to measure a foot, and FIG. 24 is a side view of FIG. 23. The subject P places the heel He of the bare foot BF between the vertical plate portions 680 and 682, brings the heel point HP into contact with the vertical plate portion 676, and aligns the center line C of the foot with the center line of the measurement tool.

In this state, the measure portion 6240 is used to measure the ball girth BG. Also, as shown in FIG. 23, the measure portion 6250 is wound around the instep Is of the bare foot BF together with a winding portion 666 for measurement. At this time, the measure portion 6250 is pulled out from the holes near the end of the foot pattern indication portion 610. The foot pattern indication portion 610 is located in a main body region 605 corresponding to the measurement insole MIS. Thus, in this measurement, instead of the instep girth WG of the bare feet BF of the subject P, a corrected instep girth CWG is measured. Likewise, the measure portion 6240 measures a corrected ball girth CBG.

However, since this method measures the foot length L of the bare foot BF, a corrected foot length CL including the toe room Th cannot be measured. As such, the data server 2 adds the toe room Th to the foot length L to calculate a corrected foot length CL.

<Manual Measurement With Foot Size Measurement Tool Using Socks>

As described above, the present inventors propose the 3D sock measurement method of the present disclosure by applying the foot size measurement tool using socks disclosed in Patent Literature 6.

FIG. 25 is a plan view showing a foot size measurement tool 6001 disclosed in Patent Literature 6. This example uses the foot size measurement tool 6001 disclosed in Patent Literature 6. This foot size measurement tool 6001 includes a first wearable element 6010 and a second wearable element 6070. As shown in FIG. 26, the first wearable element 6010 has a sock-shaped cover 6012, scale mark indicators 6040 and 6050, and a bottom plate 6060. As shown in FIG. 25, the second wearable element 6070 has a cover 6072, a ball girth measurement portion 6100, and an instep girth measurement portion 6120. As shown in FIG. 25, for measurement, the first wearable element 6010 is put on a bare foot BF of the subject P, and then the second wearable element 6070 is put on the first wearable element 6010.

The covers 6012 and 6072 are made of a material that is stretchable and flexible. The scale mark indicators 6040 and 6050, the ball girth measurement portion 6100, and the instep girth measurement portion 6120 are made of a non-stretchable material. When the foot size measurement tool 6001 is worn on the foot, the length between the ends of a belt-like portion 6102 and the length between the ends of a belt-like portion 6122 can be measured with the scale mark indicators 6040 and 6050. Based on the values obtained by adding the measured values to the length of the belt-like portion 6102 and the length of belt-like portion 6122, the ball girth and instep girth can be measured.

At this time, as shown in the cross-sectional view of FIG. 12 of the measurement sock MS worn by the subject P taken along the position of the corrected instep girth CWG, the bottom plate 6060 of the first wearable element 6010 corresponds to the measurement insole MIS of the present embodiment. In Patent Literature 6, the lengths of the ball girth BG and the instep girth WG are measured with the scale mark indicators 6040 and 6050. The measured ball girth BG corresponds to the corrected ball girth CBG of the present embodiment, and the measured instep girth WG corresponds to the corrected instep girth CWG of the present embodiment. Also, the foot length L measured with the cover 6012 of the first wearable element 6010 attached corresponds to the corrected foot length CL of the present embodiment.

The present embodiment generates foot shape specification data FSSD including corrected foot length CL, corrected ball girth CBG, and corrected instep girth CWG as described above.

<Measurement With Manual Measurement Shop Terminal 6>

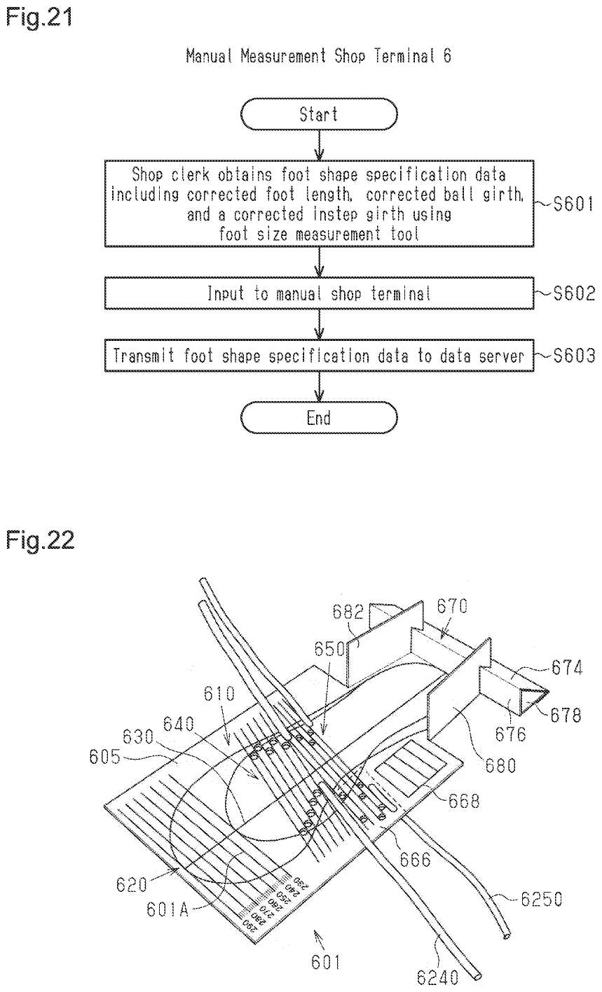

FIG. 21 is a flowchart showing a procedure for transmitting foot shape specification data FSSD from the manual measurement shop terminal 6 to the data server 2 via the communication network 10.

First, a shop clerk measures a bare foot BF of a subject of measurement P using the specialized foot size measurement tool 601 or the foot size measurement tool 6001 (S601). This measurement directly obtains a corrected ball girth CBG and a corrected instep girth CWG.

The shop clerk inputs the obtained foot shape specification data FSSD to the manual measurement shop terminal 6 using the keyboard, for example (S602). The foot shape specification data FSSD may include a foot length L or a corrected foot length CL, a corrected ball girth CBG, and a corrected instep girth CWG, for example. The terminal 6 then transmits the foot shape specification data FSSD to the data server 2 (S603). At this time, various types of manually measured data may also be transmitted. This allows the data server 2 to modify details of the shoe last SM for hallux valgus, bunionette, or the heel angle, for example, even when there is no foot shape 3D data FD3D or corrected foot shape 3D data CFSD. Patent Literatures 4 and 5 describe such modification in detail, and detailed descriptions are thus omitted.

<Shoe Last Maker Terminal 7>

FIG. 27 is a block diagram showing the configuration of the shoe last maker terminal 7. The shoe last maker terminal 7 used by a shoe last maker receives various types of data, such as foot shape specification data FSSD, transmitted from the data server 2. The user terminal 3, the 3D sock measurement shop terminal 4, the 3D virtual insole measurement shop terminal 5, and the manual measurement shop terminal 6 may all be used as foot shape specification data provider terminals. These foot shape specification data provider terminals may directly provide the shoe last maker terminal 7 with foot shape specification data FSSD. Based on the received data, the terminal 7 selects ready-made shoe lasts SM, modifies shoe lasts SM, or produce original shoe lasts SM with a 3D printer.

The shoe last maker terminal 7 is a client computer terminal and includes a computer 71 having a CPU, RAM, and ROM. The terminal 7 may include at least one of an input means 72, a display screen 73, a 3D printer 74, a communication device 75, application programs 76, and a shoe last DB 77.

The display screen 73 may be a liquid crystal display, for example. The input means 72 may be a keyboard or a mouse, for example. The 3D printer 74 may have a known configuration.

The application programs 76 include a 3D printer control program 76a, which controls the 3D printer 74, and a control and communication program 76b, which accesses the data server 2. The shoe last DB stores 3D data of the basic models of shoe lasts SM for each size, including foot shape specification data FSSD as keys.

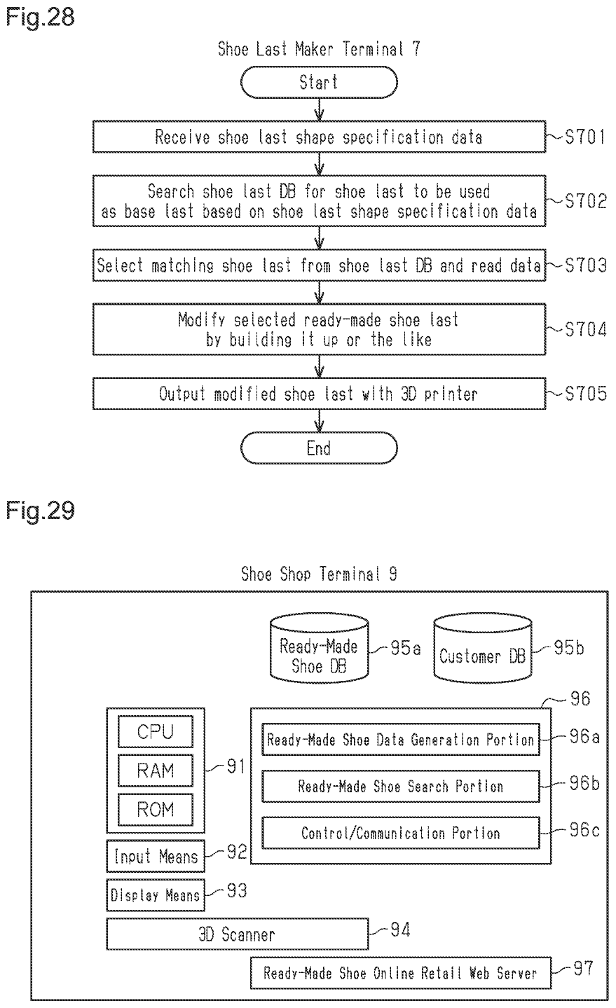

FIG. 28 is a flowchart showing a procedure performed by the shoe last maker terminal 7 receiving foot shape specification data FSSD from the data server 2.

When foot shape specification data FSSD is transmitted from the data server 2, the process starts (Start). The shoe last maker terminal 7 receives foot shape specification data FSSD transmitted from the data server 2 (S701). The shoe last maker terminal 7 adds a corrected foot length CL estimated from the foot length L to the data from the manual measurement shop terminal 6. Based on the received foot shape specification data FSSD, the shoe last maker terminal 7 refers and searches the shoe last DB 77 using predefined dimensions, such as at least one of the corrected foot length CL, corrected ball girth CBG, and corrected instep girth CWG, as arguments (S702).

The shoe last maker terminal 7 selects a shoe last SM with matching size and reads the data of the shoe last SM (S703).

When modification data, such as on hallux valgus or bunionette, is available, the shoe last maker terminal 7 modifies the selected ready-made shoe last SM by building up or cutting it (S704). Patent Literatures 4 and 5 describe such modification methods in detail, and detailed descriptions are thus omitted. The shoe last maker terminal 7 outputs the 3D data of the modified shoe last SM as the final shoe last SM using a 3D printer (S705). The shoe last SM produced in this manner is provided to the shoe maker 8. The 3D printer may be a general-purpose product, such as da Vinci Super (registered trademark) manufactured by XYZ Printing, Inc.

<Other Examples>

The shoe last maker terminal 7 does not have to include the 3D printer 74. In this case, the terminal 7 receives shoe last shape specification data (S701), searches the shoe last DB for a shoe last SM to be used as a base last based on the foot shape specification data FSSD (S702), and selects a matching shoe last SM from the shoe last DB. The shoe last maker has a prepared stock of actual shoe lasts SM made of plastic, wood, or metal for each size. The shoe last maker manually builds up or cuts the shoe last SM selected by the terminal 7 based on the modification data to produce the final shoe last SM.

<Shoe Maker 8>

The shoe maker 8 receives completed shoe lasts from the shoe last maker and physically produces custom shoes OS. Typically, custom shoes OS are produced through the steps same as the upper making step (S4), the lasting step (S5), and the bottoming step (S6) in the flowchart of FIG. 37 showing a typical conventional shoemaking process for custom shoes OS. The completed custom shoes OS are delivered to the subject P, who is the orderer. In the custom shoe OS production method of the present embodiment, the shoe lasts SM are determined based on the foot shape specification data FSSD and using the corrected foot length CL, the corrected ball girth CBG, and the corrected instep girth CWG. This ensures that the completed custom shoes OS fit the feet of the subject P, eliminating the need for the subject P to try on the custom shoe OS before completion for any adjustment as in conventional techniques.

<Shoe Shop Terminal 9>

In the present embodiment, a shoe shop is generally a shop that sells ready-made shoes RS. The shop may be a physical shop, but the present embodiment assumes that the shop is an online shop with which the customers cannot actually try on shoes.

FIG. 29 is a block diagram showing the configuration of the shoe shop terminal 9. The shoe shop terminal 9 is a client computer terminal associated with the data server 2. The terminal 9 may include a computer 91 having a CPU, RAM, and ROM, for example. The terminal 9 may include at least one of an input means 92, a display screen 93, a 3D scanner 94, a shoe last DB 95a, a customer DB 95b, an application program 96, and a ready-made shoe online retail web server 97.

The input means 92 may be a keyboard or a mouse, for example. The display screen 93 may be a liquid crystal display, for example. Unlike the 3D scanner 44 of the 3D sock measurement shop terminal 4, the 3D scanner 94 is configured to measure the internal shapes of ready-made shoes RS. For example, a 3D scanner disclosed in Japanese Patent No. 6423984 (three-dimensional shape measuring apparatus) may be used to measure the internal shapes of ready-made shoes RS. From this data, the sizes corresponding to the corrected foot length CL, corrected ball girth CBG, and corrected instep girth CWG of foot shape specification data FSSD are extracted and stored as ready-made shoe shape specification data RSID in the ready-made shoe DB 95a.

The customer DB 95b stores personal information identifying customers and information associated with the personal information. For example, the information associated with the personal information may include the corrected foot shape 3D data CFSD transmitted from the terminal 3, 4, 5, 6 to the data server 2, especially the corrected foot length CL, the corrected ball girth CBG, and the corrected instep girth CWG.

The shoe shop terminal 9 is a client terminal associated with the data server 2 as the server computer. The terminal 9 may include the ready-made shoe online retail web server 97 forming a website for online retailing of ready-made shoes RS to customers via the communication network 10 such as the Internet. In this case, the terminal 9 is used as the server computer for the terminals of customers as client terminals.

The application program 96 includes at least one of a ready-made shoe data generation portion 96a, a ready-made shoe search portion 96b, and a control and communication portion 96c. The ready-made shoe data generation portion 96a uses the 3D scanner 94 to generate a corrected foot length CL, a corrected ball girth CBG, and a corrected instep girth CWG as ready-made shoe shape specification data RSID of ready-made shoes RS. The data generation portion 96a also records in the ready-made shoe DB 95a ready-made shoe shape specification data RSID determining the internal shapes of the ready-made shoes RS owned by the shoe shop. The ready-made shoe search portion 96b compares the corrected foot length CL, the corrected ball girth CBG, and the corrected instep girth CWG of the foot shape specification data FSSD of a customer sent from the data server 2 with the corrected foot lengths CL, the corrected ball girths CBG, and the corrected instep girths CWG of the corrected foot shape 3D data CFSD that is the ready-made shoe shape specification data RSID stored in the ready-made shoe DB, and searches for and extract ones with a high degree of matching.

In this search, on the premise that the corrected foot length CL principally matches within a certain range, the degree of match of the corrected instep girth CWG is weighted. This is because the technical idea of the present disclosure is derived from the basic theory that a match of the corrected instep girth CWG results in a shoe that stably holds the foot regardless of the internal shape of the shoe.

The control and communication portion 96c is a program that performs the overall control and communication of the shoe terminal 9.

<Ready-Made Shoe Search With Shoe Shop Terminal 9>

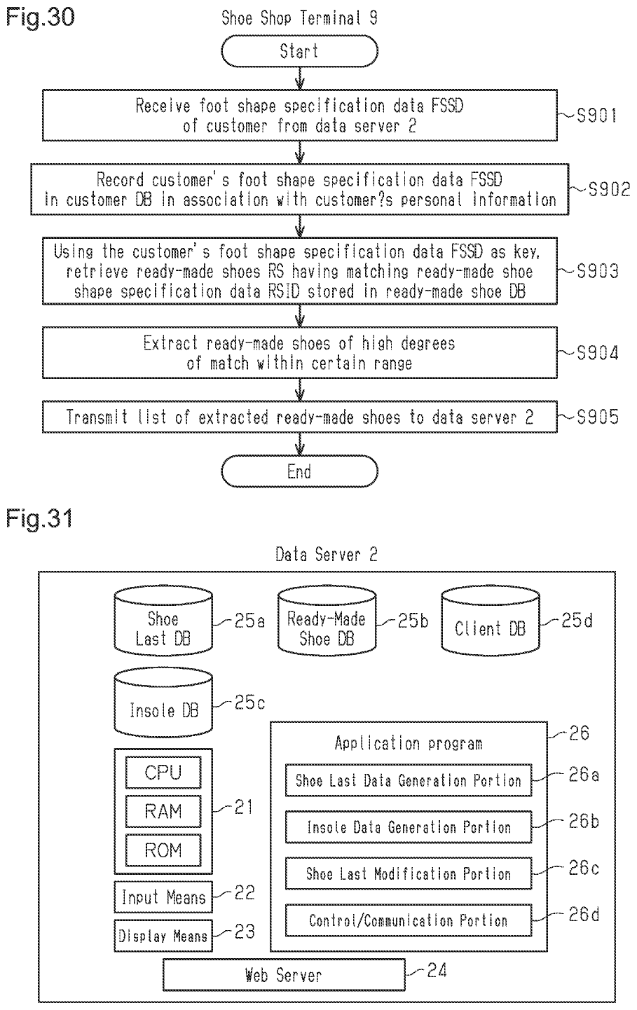

FIG. 30 is a flowchart showing a procedure for searching for ready-made shoes with the shoe shop terminal 9.

The shoe shop terminal 9 receives the foot shape specification data FSSD of a customer from the data server 2 (S901). The shoe shop terminal 9 then records the customer's foot shape specification data FSSD in the customer DB 95b in association with the customer's personal information (S902).

Using the customer's foot shape specification data FSSD as the key, the shoe shop terminal 9 retrieves ready-made shoes RS having high degrees of match with the foot shape specification data FSSD of the ready-made shoe RS from the ready-made shoe shape specification data RSID stored in the ready-made shoe DB 95a (S903).

The terminal 9 extracts ready-made shoes RS that have high degrees of match above a certain level, or ready-made shoes RS that have high degree of match within a certain range, such as the top ten pairs (S904). The shoe shop terminal 9 transmits the list of extracted ready-made shoes to the data server 2 (S905).

The shoe shop terminal 9 performs the above procedure. The shoe shop terminal 9 corresponds to the ready-made shoe selection information provider terminal of the present disclosure. As will be described below, the data server 2 may also be used as the ready-made shoe selection information provider terminal of the present disclosure.

<Data Server 2>

FIG. 31 is a block diagram showing the configuration of the data server 2. The data server 2 is a server computer that is an essential element of the custom shoe production assisting system and the ready-made shoe search system. The data server 2 provides various functions according to the capabilities of client terminals. The data server 2 may simply transfer the received foot shape specification data FSSD to the shoe last maker terminal 7 as it is. In other cases, the data server 2 may perform most of the processing in place of the client terminal.

The data server 2 includes a computer 21, an input means 22, a display means 23, and a web server 24. The computer 21 has a CPU, RAM, and ROM.

The installed application program 26 includes a shoe last data generation portion 26a. The shoe last data generation portion 26a is configured to receive foot shape specification data FSSD and determine shoe lasts SM. The program 26 may further include at least one of an insole data generation portion 26b, a shoe last modification portion 26c, or a control and communication portion 26d. The insole data generation portion 26b is configured to generate data of virtual insoles VIS and measurement insoles MIS based on the foot shape 3D data FD3D. The shoe last modification portion 26c is configured to correct the data of shoe lasts SM. The control and communication portion 26d is configured to perform the overall control and communication of the data server 2.

The data server 2 may have at least one of a shoe last DB 25a, a ready-made shoe DB 25b, an insole DB 25c, or a customer DB 25d as database used for the above processes. The shoe last DB 25a includes the data of shoe lasts SM corresponding to the corrected foot shape 3D data CFSD. The ready-made shoe DB 25b includes ready-made shoe shape specification data RSID, which determines the internal shapes of the ready-made shoes RS owned by the shoe shop. The insole DB 25c includes the data on virtual insoles VIS and measurement insoles MIS corresponding to the foot length L, ball girth BG, foot width FW, and instep girth WG of subjects of measurement P. The customer DB 25d includes the measurement values and personal information of the users of custom shoes OS, and their histories.

The data server 2 includes the web server 24 that performs control relating to the client computers and the custom shoe production assisting system and the ready-made shoe search system, which perform processing via the communication network 10, for example. The client computers include the user terminal 3, the 3D sock measurement shop terminal 4, the 3D virtual insole measurement shop terminal 5, the manual measurement shop terminal 6, the shoe last maker terminal 7, the shoe maker terminal 8, and the shoe shop terminal 9.

<Procedure of Basic Processes by Data Server 2 Relating to Custom Shoes>

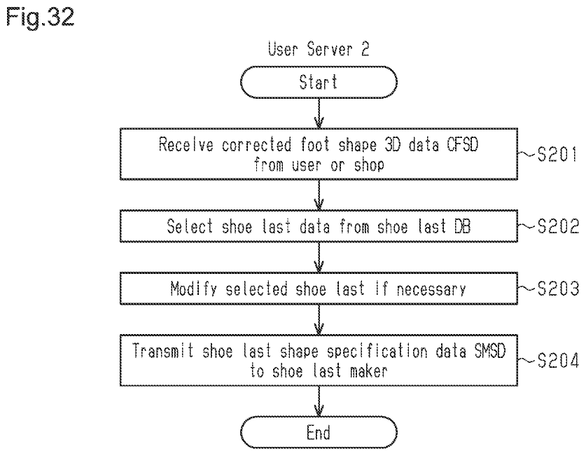

FIG. 32 is a flowchart showing the procedure of basic processes performed by the data server 2. The data server 2 performs various processes. The most basic processes among them as the custom shoe production assisting system are now described.

The data server 2 receives corrected foot shape 3D data CFSD transmitted from a user or a shop (S201). Corrected foot shape 3D data CFSD transmitted from the manual measurement shop terminal 6 includes the foot length L of the bare foot BF of the subject P instead of the corrected foot length CL. The server 2 generates a corrected foot length CL by adding the toe room Th to the foot length L. The received corrected foot shape 3D data CFSD is stored in the customer DB 25d in association with the customer's personal information. Then, the server 2 selects shoe last data from the shoe last DB 25a based on the stored corrected foot shape 3D data CFSD (S202). When the server 2 receives modification data on hallux valgus, bunionette, or other foot shape of the subject P, the server 2 generates modification data for the shoe last SM (S203). The server 2 transmits shoe last shape specification data SMSD and modification data, if any, to the shoe last maker terminal 7 (S204).

<Virtual Insole VIS Generation Procedure by Data Server 2>

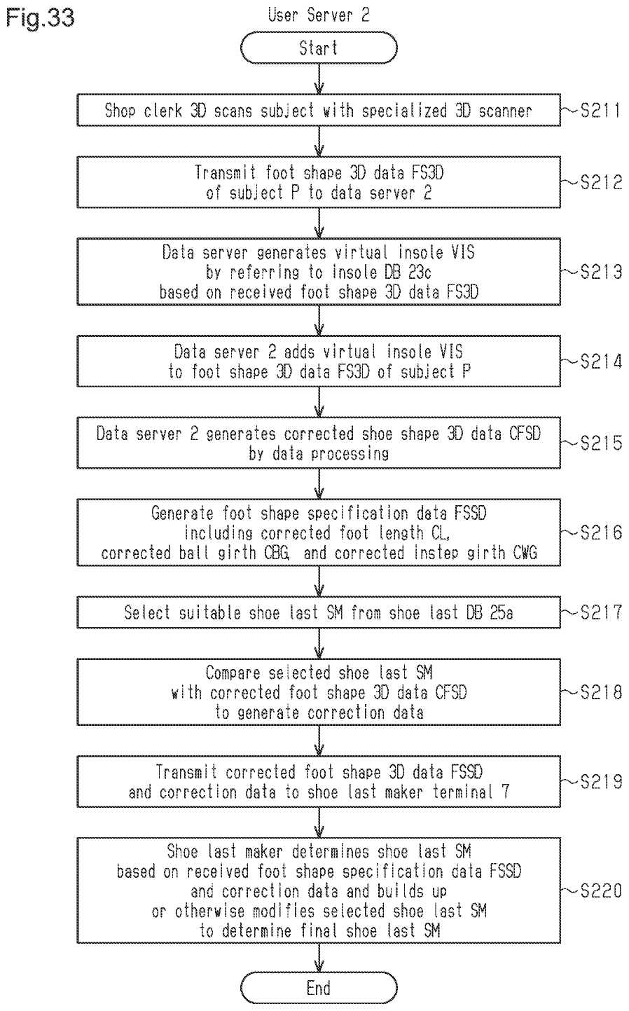

FIG. 33 is a flowchart showing the procedure performed when the data server 2 generates virtual insoles VIS.

A shop clerk uses the 3D scanner of the user terminal 3 or the 3D virtual insole measurement shop terminal 5 to 3D scan a bare foot BF of a subject of measurement P (S211). This obtains the foot shape 3D data FD3D of the subject P. The user terminal 3 or the terminal 5 transmits the obtained data FD3D to the data server 2 (S212). This completes the procedure by the user terminal 3 or the 3D virtual insole measurement shop terminal 5.

The data server 2 receives the foot shape 3D data FD3D and generates virtual insoles VIS from the received foot shape 3D data FD3D by referring to the insole DB 25c (S213). The data server 2 adds the generated virtual insoles VIS to the foot shape 3D data FD3D on the data (S214). The data server 2 generates corrected foot shape 3D data CFSD from the foot shape 3D data FD3D to which the virtual insoles VIS are added (S215). The data server 2 measures the generated corrected foot shape 3D data CFSD on the data to generate foot shape specification data FSSD (S216). The foot shape specification data FSSD includes, for example, at least one of corrected foot length CL, corrected ball girth CBG, and corrected instep girth CWG.

The data server 2 selects suitable shoe lasts SM from the shoe last DB 25a based on the predefined dimensions, such as the corrected foot length CL, the corrected ball girth CBG, and the corrected instep girth CWG (S217).

The data server 2 compares the selected shoe last SM with the shape of the generated corrected foot shape 3D data CFSD, and generates correction data on a bulge caused by hallux valgus or bunionette, or the shape or inclination of the heel (S218), for example. The data server 2 transmits the foot shape specification data FSSD to the shoe last maker terminal 7 together with the correction data (S219).

The shoe last maker receives the foot shape specification data FSSD and the correction data and determines a shoe last SM based on these data pieces. Then, the shoe last maker modifies the selected shoe last SM by building up or cutting it to determine the final shoe last SM (S220).

In this manner, the data server 2 with high processing capability performs collective processing like a cloud computer, thereby simplifying the procedure by the user terminal 3 or the shop terminal 5. This reduces the burden on the user and the shop clerk. Furthermore, reducing the load on the software and hardware of the user terminal 3 and the shop terminal 5 allows the devices to be simplified.

<Basic Procedure by Data Server 2 For Shoe Shop Terminal 9>

The most basic process by the data server 2 is to transfer the foot shape specification data FSSD received by the data server 2 to the shoe shop terminal 9 as in the procedure shown in FIG. 30. The shoe shop terminal 9 performs the subsequent processes.

<When Data Server 2 Searches Ready-Made Shoe Shape Specification Data RSID of Multiple Shoe Shops>

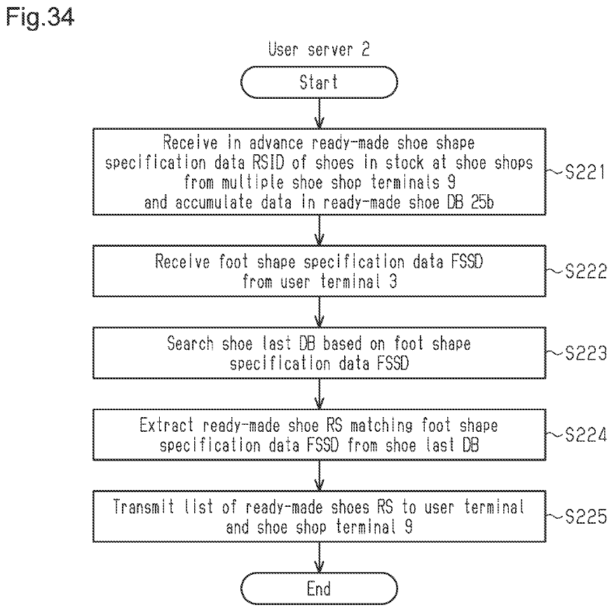

FIG. 34 is a flowchart showing a procedure by the data server 2 performing the main process of the ready-made shoe search system. Among the various processes performed by the data server 2, the process performed as the main element of the ready-made shoe search system is now described.

The data server 2 receives in advance the ready-made shoe shape specification data RSID from multiple shoe shop terminals 9, and accumulates data in the ready-made shoe DB 25b for each shop and for each ready-made shoe model and size (S221). The ready-made shoe shape specification data RSID is obtained by measuring ready-made shoes in stock at the shoe shops with 3D scanners. When shoes are produced based on common shoe lasts SM, the data of these ready-made shoes can be shared. When the ready-made shoe shape specification data RSID of a ready-made shoe RS matches the foot shape specification data FSSD, this ready-made shoe RS fits the foot of the subject P who is the user.

Then, the data server 2 receives foot shape specification data FSSD from the user terminal 3 together with criteria such as the desired shoe type and color (S222).

From the criteria specified by the user and the foot shape specification data FSSD, the data server 2 then searches the ready-made shoe DB 25b for the ready-made shoe shape specification data RSID corresponding to the foot shape specification data FSSD (S223). The data server 2 extracts ready-made shoes RS having the ready-made shoe shape specification data RSID that matches the foot shape specification data FSSD from the ready-made shoes DB 25b (S224). The data server 2 transmits a list of the ready-made shoes RS to the user terminal 3 and the shoe shop terminal 9 (S225). The user may obtain a list of ready-made shoes of multiple shoe stores.

Operation of Embodiment

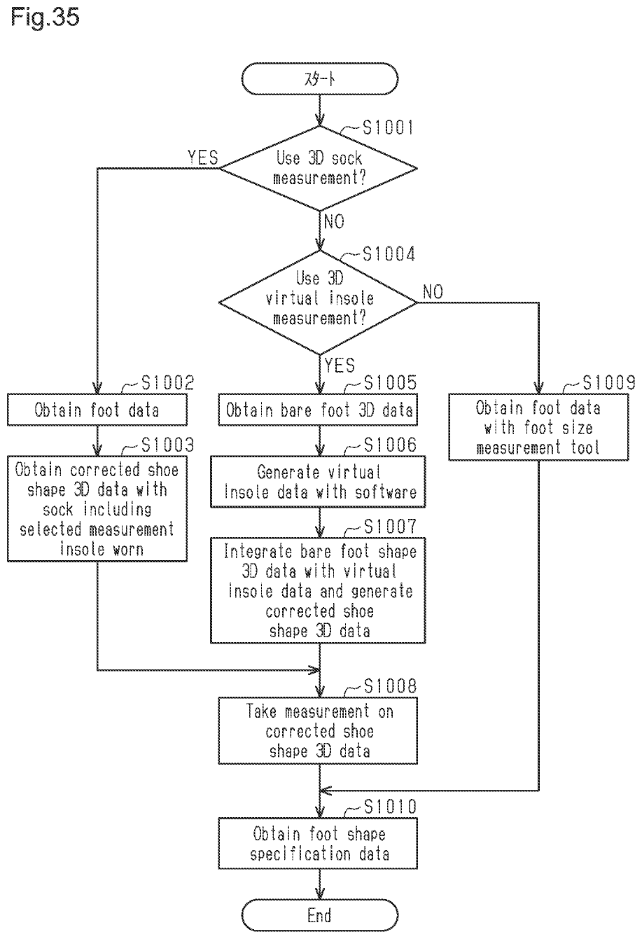

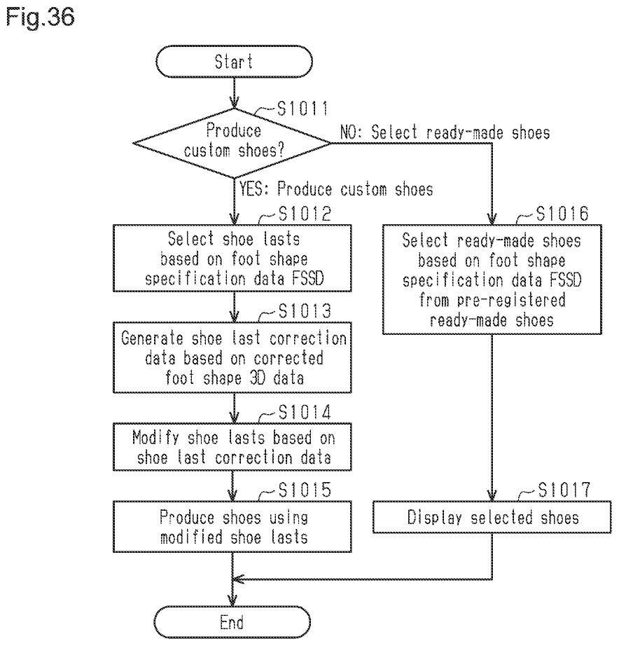

FIGS. 35 and 36 are flowcharts summarizing the procedures of the entire system 1 of the present embodiment, including the custom shoe production assisting system and the ready-made shoe search system.

The present embodiment illustrates the 3D sock measurement, 3D virtual insole measurement, and manual measurement using a foot size measurement tool as measurement for obtaining foot shape specification data FSSD.

<Obtainment of Foot Shape Specification Data>

First, when 3D sock measurement is used (S1001: YES), data of bare feet BF (foot length L and ball girth BG) of a subject of measurement P is obtained by taking measurements or the like to select measurement insoles MIS (S1002). Suitable measurement insoles MIS are thus selected. Measurement socks MS with the selected measurement insoles MIS are worn on the subject P and scanned with a 3D scanner to obtain corrected foot shape 3D data CFSD (S1003).

When 3D sock measurement is not used (S1001: NO) and 3D virtual insole measurement is performed (S1004: YES), the bare feet BF of the subject P are 3D scanned to obtain foot shape 3D data FD3D (S1005). Then, from the obtained foot shape 3D data FD3D or actual measurements, data of the bare feet BF of the subject P (foot length L and ball girth BG) is obtained on the data. Based on the obtained data, virtual insoles VIS are generated on the data (S1006), and the foot shape 3D data FD3D and the virtual insoles VIS are synthesized and integrated on the data. Corrected foot shape 3D data CFSD is generated by making correction according to the integrated shape to (S1007).

Predefined dimensions, such as corrected foot length CL, corrected ball girth CBG, and corrected instep girth CWG, are obtained on the data (S1008) from the corrected foot shape 3D data CFSD generated at S1003 or S1007 to obtain foot shape specification data FSSD (S1010).

When 3D sock measurement is not used (S1001: NO) and the 3D virtual insole is not used (S1004: NO), a person manually measures foot data using a foot size measurement tool and without using a 3D scanner (S1009). With the foot size measurement tool, the predefined dimensions, such as corrected foot length CL, corrected ball girth CBG, and corrected instep girth CWG, are obtained by directly measuring the bare feet BF of the subject P to obtain foot shape specification data FSSD (S1010).

<Production of Custom Shoes OS, Selection of Ready-Made Shoes RS>

Once the foot shape specification data FSSD is obtained as described above (S1010), the data can be used to produce custom shoes OS or select ready-made shoes RS.

To produce custom shoes OS (S1011: YES), shoe lasts SM are selected based on the obtained foot shape specification data FSSD (S1012). When corrected foot shape 3D data CFSD is available, the data is compared with the selected shoe lasts SM to generate modification data (S1013), and the shoe lasts SM are modified to accommodate hallux valgus, for example. Based on the modification data, the shape of each shoe last SM is modified by building up or cutting it (S1014). Custom shoes OS are produced based on the modified shoe lasts SM (S1015). In this manner, custom shoes that fit well can be produced without a fitting.

To select ready-made shoes RS instead of producing custom shoes OS (S1011: NO), the corrected foot length CL, corrected ball girth CBG, and corrected instep girth CWG of the obtained foot shape specification data FSSD are measured in advance with a 3D scanner and then compared with the corrected foot length CL, corrected ball girth CBG, and corrected instep girth CWG of the ready-made shoe shape specification data RSID to select ready-made shoes RS of approximate dimensions (S1016). The selected ready-made shoes RS are displayed to the customer. In this manner, ready-made shoes RS that fit well can be purchased without a fitting.

Advantages of First Embodiment

(1) The use of the measurement insole MIS, the virtual insole VIS, and the foot size measurement tools 601 and 6001 enables the production of custom shoes OS that fit the feet of the subject P based on the foot shape specification data FSSD. The foot shape specification data FSSD includes predefined dimensions, such as at least one of a corrected foot length CL, a corrected ball girth CBG, or a corrected instep girth CWG.

(2) The use of the measurement insole MIS, the virtual insole VIS, and the foot size measurement tools 601 and 6001 enables the selection of ready-made shoes RS that fit the feet of the subject P based on the foot shape specification data FSSD.

(3) The foot shape specification data FSSD, which is small in data amount, allows for the determination of shoes that fit the feet of the subject P even if a 3D scanner is not used.

(4) In particular, the determination based on the corrected instep girth CWG results in shoes that are properly held on the feet of the subject P in a suitable and stable manner regardless of the specific shapes of the shoes.

(5) Thus, the production of custom shoes OS and selection of ready-made shoes RS are typically achieved based on the foot shape specification data FSSD without a fitting.

(6) The foot shape specification data FSSD is obtainable through various methods including the measurement insole MIS, the virtual insole VIS, and the foot size measurement tool 601, 6001.

(7) In the 3D sock measurement, accurate corrected foot shape 3D data CFSD can be obtained by a single 3D scanning process performed with a measurement insole MIS set in a measurement sock MS. This allows the corrected foot length CL, the corrected ball girth CBG, and the corrected instep girth CWG to be measured typically without correcting the data.

(8) The measurement insole MIS can be easily selected by preparing patterns corresponding to shoe lasts SM of different foot lengths L and widths.

(9) The foot shape 3D data FD3D may be used to generate an optimum virtual insole VIS corresponding to the parting line of the foot. By producing a shoe last using a 3D printer based on corrected foot shape 3D data CFSD generated based on the above data, a custom shoe OS that fit the foot of the subject P can be produced even when the shape of the foot is unique.

(10) With the 3D virtual insole measurement, once the bare foot BF of the subject P is 3D scanned, a suitable virtual insole VIS can be produced through data processing. This allows for the obtainment of corrected foot shape 3D data CFSD and the measurement of a corrected foot length CL, a corrected ball girth CBG, and a corrected instep girth CWG. Accordingly, the procedure performed by the subject P, who is the user, is significantly simple.

(11) With the 3D virtual insole measurement, the measurement insole MIS, the measurement sock MS, and the foot size measurement tools 601 and 6001, which are physical items, are not required. This method is thus easily used for online retailing via smartphones and the like.

(12) The measurement using the foot size measurement tool 601, 6001 does not require a computer, let alone a 3D scanner. This method allows a shop or a user without such equipment to easily and accurately measure a corrected foot length CL, a corrected ball girth CBG, and a corrected instep girth CWG. Even when 3D data is not available, custom shoes OS and ready-made shoes RS can be ordered simply by sending the corrected foot length CL, corrected ball girth CBG, and corrected instep girth CWG. Accordingly, shoes that fit the feet of the subject P can be produced or selected even when the 3D shapes of the feet are unknown.

(13) By using the system 1 described above, anyone, not only skilled professionals or salespersons, can provide shoes that fit the feet of the subject P.

Second Embodiment

A second embodiment of the present disclosure is now described. The virtual insole VIS and the measurement insole MIS of the first embodiment are basically designed to reproduce the internal space created when the custom shoe OS is worn by a healthy subject. For this reason, their thicknesses are set to be thin enough not to influence the measurement of the corrected instep girth CWG.

However, in some cases, the subject of measurement P may have flat feet, leg length discrepancy, or soles SI that are inclined sideways due to bow-legs or knock-knees. It may be impossible for custom shoes OS alone to correct such conditions. Conventionally, adjustments have been made using a foot orthosis FP formed by a sole plate having the shape of a bare foot BF of the subject P, or a foot orthosis FP that is described in Japanese Patent Application Publication No. 2014-180380 (shoe insole) and is produced by a prosthetist, for example.

The second embodiment includes such a foot orthosis FP in place of the virtual insole VIS or the measurement insole MIS. The foot orthosis FP, which is also referred to as a sole plate, is used when the subject P has the above-mentioned conditions that cannot be accommodated by normal custom shoes OS.

Conventionally, correction of the shapes of feet of the subject P using foot orthoses FP is predicated on the use of ready-made medical shoes. To accommodate foot orthoses FP of varying thicknesses, one-size-fits-all shoes that are fastened with hook-and-loop fasteners are often used.

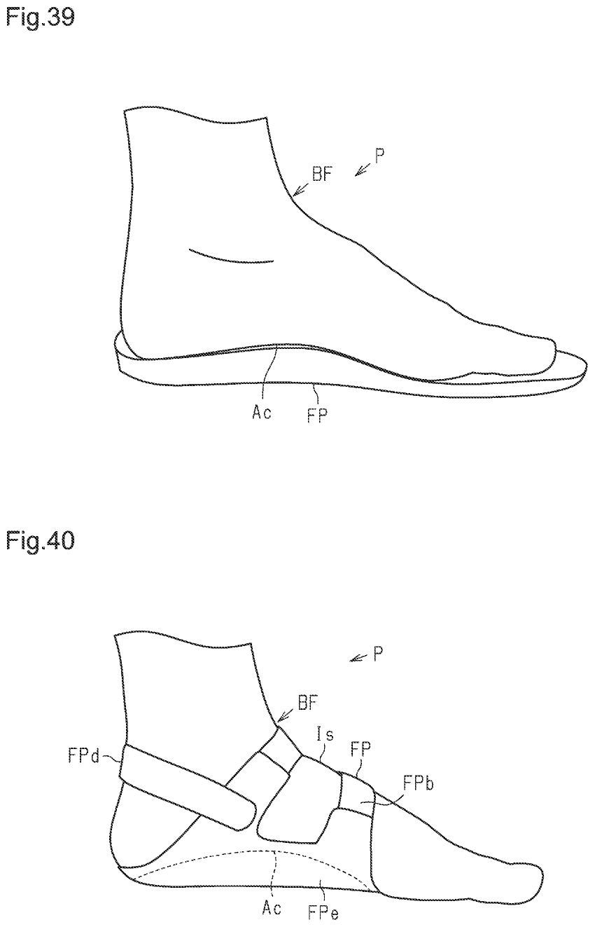

FIG. 39 is a perspective view showing an example of a foot orthosis FP formed by a sole plate attached to a bare foot BF of a subject of measurement P. For example, when the bare foot BF is a flat foot, there is no space at the arch Ac of the bare foot BF before correction. The illustrated foot orthosis FP provides a cushion at the position of the sole plate FPa corresponding to the arch AC when this foot orthosis FP is used. As a result, the portion of the arch Ac is corrected into an arch shape. Furthermore, the sole plate FPa may be shaped to extend over the entire sole SI to the toe To, and the peripheral edge of the sole plate FPa has an edge portion FPc shaped to surround the sole SI. This increases the stability of the sole Sl. Also, the foot orthosis FP may be formed by taking impression of the bare foot BF of the subject P. In this case, the sole plate FPa may have a raised portion FPb reflecting the shape of the bare foot BF to conform to the individual shape of the bare foot BF of the subject P.

Also, when the foot orthosis FP consists only of the sole plate FPa as in this example, the sole plate FPa can be fixed to the sole Sl with an adhesive or adhesive tape as shown in FIG. 39. Alternatively, as will be described below, measurement may be performed by fixing the sole plate FPa with a measurement sock MS.

FIG. 40 is a side view showing another example of a foot orthosis FP attached to a bare foot BF of a subject of measurement P. With the foot orthosis FP of this example, the sole plate FPe includes only the portion corresponding to the arch Ac and does not include the toe To. Furthermore, the foot orthosis FP is fixed to the instep Is or the like with a fixing belt FPd.

The second embodiment measures a foot of the subject P with a foot orthosis FP worn on the bare foot BF of the subject P. Preferably, a method such as that of the measurement using the 3D scanner described in <3D Sock Measurement Shop Terminal 4>or the measurement in <Manual Measurement with Foot Size Measurement Tool using Socks>may be suitably applied as it is, except that the measurement insole MIS is replaced by the foot orthosis FP. Thus, the detailed description of the procedure is omitted.

The second embodiment is not necessarily limited to the measurement using the measurement sock MS. Other methods may be used as long as foot shape specification data FSSD is obtained by measuring a foot of the subject P with a foot orthosis FP attached to the bare foot BF of the subject P. The foot shape specification data FSSD includes predefined dimensions, such as at least one of corrected foot length CL, corrected ball girth CBG, and corrected instep girth CWG. In particular, the corrected instep girth CWG is essential.

Operation of Second Embodiment

The method for producing shoes according to the second embodiment collects foot shape specification data FSSD including a corrected foot length CL, a corrected ball girth CBG, and a corrected instep girth CWG with foot orthoses FP attached to the feet. Accordingly, shoe lasts SM can be produced based on the collected foot shape specification data FSSD. When custom shoes OS are produced using the shoe lasts SM thus produced, the custom shoe OS fit the feet of the subject P to which the foot orthoses FP are attached.

The data FSSD measured by the method described above may be used by a shoe last maker to produce shoe lasts SM using a 3D printer 74 as shown in FIG. 27. The shoe last maker can thus produce original shoe lasts SM that are different from ready-made products. As a result, original custom shoes OS can be produced that fit well with the foot orthoses FP attached to the subject P.

Advantages of Second Embodiment

(14) When the bare feet BF of the subject of measurement P have irregular shapes, such as when the subject P has flat feet, leg length discrepancy, or soles that are inclined sideways due to bow-legs or knock-knees, shoe lasts of any desired design can be produced according to the request of the subject P. As such, custom shoes OS can be produced that have an aesthetically pleasing design and yet fit the feet that are being corrected by foot orthoses FP.

Other Examples

The communication of data on corrected foot length CL, corrected ball girth CBG, and corrected instep girth CWG is not limited to the transmission and reception by computers. The data may be input verbally, by telephone, or by facsimile to the data server 2, the shoe last maker terminal 7, the shoe shop terminal 9, or the like. This is because the essence of the present disclosure is to determine the shoe shape by the system 1 using the foot shape specification data FSSD, especially the corrected instep girth CWG.

In the present embodiment, the corrected instep girth CWG is illustrated as an example of foot shape specification data FSSD. However, a method that estimates the corrected instep girth CWG by measuring a position different from the position of actual corrected instep girth CWG, and a method that derives a value corresponding to the corrected instep girth CWG from values of approximate positions by tolerating errors fall within the scope of the technical idea of the present embodiment and are thus considered as embodiments of the present disclosure, even if the corrected instep girth CWG is referred to by different names.

The flowcharts are examples, and their components may be added, deleted, modified, or changed in order.

The components of the embodiments may be combined to the extent that does not cause contradiction.

The shoe last SM is not limited to an integral plastic member, may be made of wood, metal, or the like, and may be configured to be dividable.

The shoe last SM does not necessarily need to be modified with modification data.

In addition to fixing with the measurement sock MS, the measurement insole MIS may be fixed for measurement with an adhesive, glue, adhesive tape, adhesive sheet, or the like.

The system of the present disclosure includes both the custom shoe production assisting system and the ready-made shoe search system. However, the system may include only one of the systems. Also, the components of the system shown in FIG. 6 are merely examples. Various other components may be used, multiple components may form one component, or one components may serve as multiple components.

The data server 2 and each client terminal can share the processing depending on their capabilities and environments. Some examples of sharing are described in the embodiment.

Each computer system described herein is an example, and may be formed by multiple computer systems, or may perform distributed processing.

Although the Internet is illustrated as an example of the communication network 10, any communication means may be used such as a wireless telephone line and a dedicated line. The present system maintains its overall function as a system even when it partially includes a step of manual input by a person, for example.

The present disclosure is not limited to the illustrated embodiments. The present disclosure can, of course, be implemented by those skilled in the art by adding, deleting, and changing the configuration without departing from the scope of claims.

### REFERENCE SIGNS LIST

1 . . . System; 2 . . . Data Server (Foot Shape Specification Data Provider Terminal); 21 . . . Computer; 22 . . . ROM; 23 . . . RAM; 24 . . . Communication Interface; 25a . . . Shoe Last DB; 25b . . . Ready-Made Shoe DB; 25c . . . Insole DB; 25d Customer DB; 26a Shoe Last Data Generation Portion; 26b . . . Insole Data Generation Portion ; 26c . . . Shoe Last Modification Portion; 3 . . . User Terminal (Smartphone; Foot Shape Specification Data Provider Terminal); 38 . . . Marker Board; 4 . . . 3D Sock Measurement Shop Terminal (Foot Shape Specification Data Provider Terminal); 44 . . . 3D Scanner; 5 . . . 3D Virtual Insole Measurement Shop Terminal (Foot Shape Specification Data Provider Terminal); 54 . . . 3D Scanner; 6 . . . Manual Measurement Shop Terminal (Foot Shape Specification Data Provider Terminal); 7 . . . Shoe Last Maker Terminal; 8 . . . Shoe Maker; 9 . . . Shoe Shop Terminal; 94 . . . 3D Scanner; 10 . . . Communication Network; 601, 6001 . . . Foot Size Measurement Tool; MS . . . Measurement Sock; FSSD . . . Foot Shape Specification Data; FD3D . . . Foot Shape 3D Data; CFSD . . . Corrected Foot Shape 3D Data; RSID . . . Ready-Made Shoe Shape Specification Data; OS . . . Custom Shoe; RS . . . Ready-Made Shoe; SM . . . Shoe Last; Th . . . Toe Room; Hp . . . Raised Portion; IS . . . Insole; Os . . . Outsole; UP . . . Upper Leather; N . . . Nail; VIS . . . Virtual Insole; MIS . . . Measurement Insole; FP . . . Foot Orthosis; SK . . . Measurement Sock; BF . . . Bare Foot; Sl . . . Sole; To . . . Toe; He . . . Heel; Is . . . Instep; AS . . . Space (Under Arch AC); B4 . . . First To Fifth Distal Phalanges; B3 . . . First To Fifth Proximal Phalanges; B2 . . . First To Fifth Metatarsal Bones; B1 . . . Cuneiform Bone; BJ . . . Ball of Big Toe; STB . . . Ball of Small Toe; Ac . . . Arch; FW . . . Foot Width; HP . . . Heel Point; C . . . Center Line; L . . . Foot Length; CL . . . Corrected Foot Length; BG . . . Ball Girth; CBG . . . Corrected Ball Girth; WG . . . Instep Girth; CWG . . . Corrected Instep Girth; P . . . Subject of measurement

1. A method for generating foot shape specification data, the method comprising:
obtaining foot shape 3D data by measuring a three-dimensional shape of a bare foot of a subject of measurement;
generating a virtual insole for measurement based on the obtained foot shape 3D data;
generating corrected foot shape 3D data by adding data of the virtual insole to a sole portion of the obtained foot shape 3D data; and
obtaining foot shape specification data by measuring a predefined dimension of the corrected foot shape 3D data to determine a foot shape.

2. A method for generating foot shape specification data, the method comprising:
obtaining foot shape data that is data on a shape of a bare foot of a subject of measurement;
determining a measurement insole based on the obtained foot shape data;
generating corrected foot shape 3D data by measuring a three-dimensional shape of the foot of the subject of measurement with the determined measurement insole placed on a sole of the subject of measurement; and
obtaining foot shape specification data by measuring a predefined dimension of the corrected foot shape 3D data to determine a foot shape.

3. A method for generating foot shape specification data, the method comprising:
obtaining foot shape data that is data on a shape of a bare foot of a subject of measurement;
determining a measurement insole based on the obtained foot shape data;
obtaining corrected foot shape 3D data by measuring a three-dimensional shape of the foot of the subject of measurement using a measurement sock including the determined measurement insole with the measurement insole placed on a sole of the subject of measurement; and
obtaining foot shape specification data by measuring a predefined dimension of the corrected foot shape 3D data to determine a shape of the foot.

4. The method for generating foot shape specification data according to claim 1, wherein the foot shape specification data includes a corrected instep girth based on the corrected foot shape 3D data.

5. A custom shoe production assisting system for assisting custom shoe production in which custom shoes are produced using shoe lasts, the system comprising:
a foot shape specification data provider terminal configured such that foot shape specification data is input to the foot shape specification data provider terminal, wherein the foot shape specification data is obtained by the method for generating foot shape specification data according to claim 1, or by manually measuring the foot shape specification data by a measurer with a measurement insole placed on a foot of a subject of measurement, and the foot shape specification data provider terminal is configured to transmit the input foot shape specification data; and
a shoe last maker terminal configured to identify a corresponding shoe last from a plurality of shoe lasts based on the foot shape specification data transmitted from the foot shape specification data provider terminal,
wherein the foot shape specification data transmitted from the foot shape specification data provider terminal includes a corrected instep girth.

6. A ready-made shoe search system for retrieving ready-made shoes suitable for a subject of measurement, the system comprising:
a foot shape specification data provider terminal configured such that foot shape specification data is input to the foot shape specification data provider terminal, wherein the foot shape specification data is obtained by the method for generating foot shape specification data according to claim 1, or by manually measuring the foot shape specification data by a measurer with a measurement insole placed on a foot of the subject of measurement, and the foot shape specification data provider terminal is configured to transmit the input foot shape specification data; and
a ready-made shoe selection information provider terminal configured to receive the transmitted foot shape specification data, retrieve ready-made shoes matching the subject of measurement based on the received foot shape specification data, and provide information on the retrieved ready-made shoes,
wherein the transmitted foot shape specification data includes a corrected instep girth.

7. A method for producing shoes, the method comprising:
selecting a corresponding shoe last from a plurality of shoe lasts based on the foot shape specification data according to claim 1; and
producing a shoe using the selected shoe last.

8. The method for producing shoes according to claim 7, further comprising modifying the selected shoe last based on the corrected foot shape 3D data.

9. A method for producing shoes, the method comprising:
selecting corresponding shoe last data from a plurality of pieces of shoe last data based on the foot shape specification data according to claim 1;
correcting the shoe last data based on the corrected foot shape 3D data; and
producing a shoe last with a 3D printer based on the corrected shoe last data.

10. A ready-made shoe search method comprising:
selecting, in correspondence with the foot shape specification data according to claim 1, a matching ready-made shoe from a plurality of ready-made shoes having ready-made shoe shape specification data registered in advance; and
displaying the selected ready-made shoe.

11. A custom shoe production assisting system that comprises a computer and is configured to assist custom shoe production in which custom shoes are produced using shoe lasts, wherein the computer is configured to:
obtain foot shape 3D data by measuring a three-dimensional shape of a bare foot of a subject of measurement;
generate data of a virtual insole for measurement based on the obtained foot shape 3D data;
generate corrected foot shape 3D data by adding the data of the virtual insole to a sole portion of the obtained foot shape 3D data;
obtain foot shape specification data by measuring a predefined dimension of the corrected foot shape 3D data to determine a foot shape; and
select a shoe last corresponding to the foot shape specification data from a plurality of shoe lasts.

12. (canceled)

13. (canceled)

14. A ready-made shoe search system that comprises a computer and is configured to retrieve a ready-made shoe suitable for a subject of measurement, wherein the computer is configured to:
obtain foot shape 3D data by measuring a three-dimensional shape of a bare foot of the subject of measurement;
generate data of a virtual insole for measurement based on the obtained foot shape 3D data;
generate corrected foot shape 3D data by adding the data of the virtual insole to a sole portion of the obtained foot shape 3D data;
obtain foot shape specification data by measuring a predefined dimension of the corrected foot shape 3D data to determine a foot shape; and
select a ready-made shoe using the foot shape specification data from a plurality of types of prepared ready-made shoes.

15. (canceled)

16. (canceled)

17. The ready-made shoe search system according to claim 6, wherein when the ready-made shoe is retrieved, the foot shape specification data is compared with corresponding ready-made shoe shape specification data of the ready-made shoe.

18. A method for generating foot shape specification data comprising:
attaching, to a sole of a subject of measurement, a foot orthosis for correcting a shape of the sole according to the shape of the sole of the subject of measurement;
generating corrected foot shape 3D data by measuring a three-dimensional shape of a foot of the subject of measurement with the foot orthosis attached;
obtaining foot shape specification data by measuring a predefined dimension of the corrected foot shape 3D data to determine a shape of the foot.

19. (canceled)

20. The method for generating foot shape specification data according to claim 18, wherein the foot shape specification data includes a corrected instep girth based on the corrected foot shape 3D data.
